(19) United States
(12) Patent Application Publication
(10) Pub. No.: US 2002/0143646 A1
(43) Pub. Date: Oct. 3, 2002

(54) Method and system for a full-service electronic auction using a computer

(76) Inventors: Adam Gilbert Boyden, Palo Alto, CA (US); Adam Dawes, San Francisco, CA (US); Andrew Iorgulescu, San Francisco, CA (US); Brian Ng, San Francisco, CA (US); Claus Moldt, Mountain View, CA (US); David Elder, San Mateo, CA (US); Erik Thomas Peterson, Palo Alto, CA (US); Jorge Borbolla, Los Altos, CA (US); Julias Shaw, Mountain View, CA (US); Peter Kelly, Menlo Park, CA (US); Willima Kenji Morrow, New York, NY (US); William Wilson, Foster City, CA (US)

Correspondence Address: PERKINS COIE LLP, PATENT-SEA, P.O. BOX 1247, SEATTLE, WA, 98111-1247, US

(21) Appl. No.: 09/898,531

(22) Filed: Jul. 2, 2001

Related U.S. Application Data
(63) Continuation of application No. 09/699,301, filed on Oct. 27, 2000, now abandoned.

(51) Int. Cl. G06F 17/60

(52) U.S. Cl. 705/26; 705/1

(57) ABSTRACT

A method and system using a computer for presenting vehicles for sale at an electronic auction. In one embodiment, the method comprises providing validated data regarding a specific vehicle that is to be presented for sale at the electronic auction. The accuracy of the data can be validated by comparing initial data regarding the vehicle provided by the seller with corresponding reference data to produce the validated data. The method can also include determining a first valuation for the vehicle by mapping the validated data to itemized valuation data. The method can also be directed toward a full-service business-to-business electronic auction of used vehicles in which the electronic auctioneer arranges for transportation of the vehicles and coordinates the financial transactions between the buyers, sellers and third-party providers.

### RELATED APPLICATIONS

This application is related to co-pending applications filed on the same day entitled (a) METHOD AND SYSTEM OF PRESENTING USED VEHICLES FOR SALE AT AN ELECTRONIC AUCTION (identified by Perkins Coie LLP Docket No. 32913.8001 US), and (b) METHOD AND SYSTEM OF VALUATING USED VEHICLES FOR SALE AT AN ELECTRONIC AUCTION USING A COMPUTER (identified by Perkins Coie LLP Docket No. 32913.8002 US), which are herein incorporated by reference.

### TECHNICAL FIELD

The present invention generally relates to conducting at least part of a commercial transaction on a computer network. More particularly, several aspects of the present invention relate to methods and systems of using a computer to provide a full-service electronic auction of used vehicles in the wholesale used vehicle market.

### BACKGROUND

The Internet is used to conduct “electronic commerce” because it facilitates electronic communications between vendors and purchasers. The Internet comprises a vast number of computers and computer networks that are interconnected through communication channels. The term “electronic commerce” refers generally to commercial transactions that are at least partially conducted using the computer systems of the parties to the transactions. A purchaser, for example, can use a personal computer to connect via the Internet to a vendor's computer. The purchaser can then interact with the vendor's computer to conduct the transaction. Although many of the commercial transactions that are performed today could be performed via electronic commerce, the acceptance and wide-spread use of electronic commerce depends, in large part, upon the ease-of-use of conducting such electronic commerce, the accuracy of the representations made by sellers, and the ability to profitably market merchandise. If electronic commerce can be easily conducted, then even novice computer users will be more likely to engage in electronic commerce, and sophisticated users will be more likely to engage in complex business-to-business transactions. Additionally, if sellers can sell items for the highest price that the market will bear, then more sellers are likely to use electronic commerce. Therefore, it is important to develop techniques that facilitate conducting electronic commerce.

The Internet facilitates conducting electronic commerce, in part, because it uses standardized techniques for exchanging information. Many standards have been established for exchanging information over the Internet, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies a specific URL for a specific web page and a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a special purpose application program (e.g., a “browser”) that effectuates the requesting of web pages and the displaying of web pages.

Web pages are generally defined using HyperText Markup Language (“HTML”). HTML provides a standard set of tags that define how a web page is to be displayed. An HTML document, for example, contains various tags that control the text display, graphics, controls, and other features. The HTML document may also contain URLs of other web pages that are available on that server computer system or other server computer systems. When a user indicates to the browser to display a web page, the browser sends a request to the server computer system to transfer to the client computer system an HTML document that defines the web page. When the requested HTML document is received by the client computer system, the browser displays a web page as defined by the HTML document.

The WWW portion of the Internet is especially useful for conducting electronic commerce. Many web servers have been developed for advertising and selling goods. The products can include items that can be delivered electronically to the purchaser over the Internet (e.g., music). The products can also include other items (e.g., books, clothes and electronics equipment) that can be delivered through conventional distribution channels (e.g., a common carriers). A vendor server computer system may provide an electronic version of a catalogue that lists the items that are available for purchase. A potential buyer may browse through the catalogue using a browser, and then the buyer can select various items that are to be purchased. When such a user has completed selecting the items to be purchased, the vendor server computer system typically prompts the user for information to complete the transaction. This purchaser-specific order information may include the purchaser's name, payment information (e.g., credit card number), and a shipping address. The vendor sever computer system typically confirms the order by sending a confirming web page and/or an electronic mail message to the client computer system, and then the vendor server system schedules the shipment of the items.

The WWW is also being used to conduct other types of commercial transactions. For example, some server computer systems have been developed to support conducting electronic auctions. In a typical electronic auction, a seller provides a definition of the item to an auction server computer system operated by an electronic auctioneer. Such a definition generally includes a description of the item, an auction time period, and a minimum bid. The auction server computer system contains an auction routine defined by a series of web pages that conducts the auction during a specified time period. Potential buyers can search the auction server computer system for an auction of interest, and when such an auction is found, the potential buyer can view the bidding history of the auction and enter a bid for the item. When the auction is closed, the auction server computer system notifies the winning bidder and the seller (e.g., usually via electronic mail) so that they can complete the transaction separately from the electronic auctioneer.

One application of electronic auctions is selling used cars over the Internet. The used car market is divided into a retail segment and a wholesale segment. In the retail segment, individuals or dealers sell used vehicles to individuals. Electronic auctions for vehicles, such as autobytel.com, autonation.com, caipoint.com, etc., have been used to sell used cars to individuals in the retail segment. The sellers in the retail segment of electronic auctions for used cars generally provide the information about a specific vehicle to an electronic auction site, and then the buyer and seller are generally responsible for completing a transaction (e.g., arranging payment and transportation). In a typical application of an electronic auction for used vehicles in the retail segment, the buyer has an opportunity to inspect the vehicle after closing the auction and before paying for the vehicle. Moreover, the sellers, and not the electronic auctioneer are responsible for providing accurate information on the web site because the sellers are generally individuals or dealers that have personal knowledge of the used vehicle. Prospective buyers in the retail segment of the used car market, therefore, generally do not rely on the electronic auctioneer to confirm that the information about a specific vehicle on the web site is accurate.

The wholesale segment for selling used cars is more complex and much less efficient than the retail segment. The sellers in the wholesale segment are generally lending institutions that receive vehicles at the end of leases, rental car companies, and businesses or government entities that operate large vehicle fleets. The buyers in the wholesale segment are generally automobile dealerships. The difficulties of using an electronic auction to market vehicles in the wholesale segment are best understood in the context of conventional physical auctions for the wholesale segment.

Conventional physical auctions for used vehicles in the wholesale segment are inefficient. In a typical situation, the used vehicle is (a) returned to the lender or removed from a fleet, (b) transported to an auction site, (c) inspected by an appraiser, (d) reconditioned for sale at a physical auction, (e) sold at a live-in-person auction for major sellers on a set day, and (f) transported from the physical auction site to the buyer. A vehicle may wait 4-45 days to be shipped from the lender or fleet operator to the auction site, and then the vehicle may wait at the auction site for an additional 20-40 days before a scheduled auction day. For example, the typical delay for a vehicle from the end of a lease until it is sold at a physical auction is approximately 20-90 days. The major sellers of leased vehicles (e.g., lending institutions) accordingly incur large expenses for the cost of capital and depreciation over this period. Additionally, the vehicle must be transported from the drop-off site to the auction site, and then from the auction site to the buyer. The sellers typically pay for at least one leg of transporting the used vehicles from the drop-off sites to the buyers. As such, conventional physical auctions for selling used cars in the wholesale market are complex and inefficient.

Although electronic auctions have been used to sell used vehicles in the retail segment, electronic auctions face particular obstacles for use in selling used vehicles between businesses in the wholesale segment. One concern of using electronic auctions in the wholesale segment is verifying the accuracy of the data provided by the seller. In physical auctions for the wholesale segment, the buyers of used vehicles generally rely on the auctioneer to provide accurate information about the vehicles and to coordinate payment. For example, the auctioneer can physically inspect the car to verify data about a vehicle before listing the vehicle in the auction program, and the buyers can physically inspect the vehicles before or during the auction. In a business-to-business electronic auction for used vehicles, a buyer in the wholesale segment cannot physically inspect the vehicles itself because the vehicles are not located at a single site. The buyers are thus expected to rely on the electronic auction site to provide accurate, verified information. The electronic auctioneer, however, cannot physically inspect the vehicles itself to verify the information provided by the sellers because the vehicles are located all across the country. Therefore, it would be desirable to develop a method and system for verifying the accuracy of the information provided by the sellers for electronically auctioning used vehicles in the wholesale segment.

Another concern of using electronic auctions to sell used vehicles in the wholesale segment is that sellers do not use consistent nomenclature for the various names, series and features of the vehicles. A seller, for example, may incorrectly identify some of the features on a vehicle because they use inconsistent terms. Therefore, it would also be desirable to reduce the potential for errors caused by using incorrect nomenclature in presenting automobiles for sale in electronic auctions for the wholesale used vehicle market.

Still another concern of using electronic auctions to sell used vehicles in the wholesale segment is that it is difficult to provide an accurate valuation for a vehicle. In a typical electronic environment, a buyer/seller can select a link on the auction web page to a website of a valuation service and complete a checklist provided by the valuation service. The valuation service then computes a wholesale or retail valuation and sends a web page to the buyer/seller with a total, non-itemized valuation for the vehicle. The sellers in a wholesale environment, however, generally do not want to expend the time to complete the checklist, and the sellers often do not have accurate and complete information on a vehicle. The valuation of a vehicle in the electronic wholesale environment may accordingly be inaccurate. Moreover, a wholesale buyer may want a valuation from a different valuation service than the service used by the seller. Thus, it would be further desirable to provide both sellers and buyers accurate valuations that itemize the components of a vehicle from a number of valuation services.

Yet another concern of using electronic auctions to sell used vehicles in the wholesale segment is that it is challenging to coordinate shipment of the vehicles to the buyers. The vehicles in a conventional physical auction are at a single location, and thus it is relatively easy for the buyers to arrange transportation for all of the vehicles that they purchase from the single physical auction site to their dealerships. It is much more challenging to arrange transportation of the vehicles in an electronic auction because the vehicles are located at a number of individual seller locations, and neither the sellers nor the buyers may be willing to arrange for the transportation of each individual car from each individual site. Moreover, unlike shipping packages using a package carrier (e.g., UPS, Federal Express, etc.), the cost to transport vehicles is not a set amount from a fee table. The cost to transport a vehicle is a function of how many vehicles are being shipped from one single location to another, the proximity to major metropolitan centers, the mode of transportation (e.g., truck or rail), and the availability of a carrier. The cost of shipping a vehicle accordingly varies and is not necessarily a set amount from a fee table. As such, if an electronic auctioneer offers to arrange for the shipment of a vehicle from a seller to a buyer, the electronic auctioneer is at risk for any differential between the quoted price and the actual cost to ship a vehicle. Electronic auctioneers are accordingly reluctant to guarantee shipping a vehicle for a quoted price to provide a full-service electronic auction for used vehicles in the wholesale segment.

### BRIEF DESCRIPTION OF THE DRAWINGS

FIG. 1 is a schematic illustration of an arrangement using an embodiment of the invention that supports performing a transaction for a business-to-business electronic auction of used vehicles over the Internet using the World Wide Web.

FIGS. 2A-2J illustrate a portion of a process for performing a business-to-business electronic auction of used vehicles using the World Wide Web in accordance with an embodiment of the invention.

FIGS. 3A-3O illustrate another portion of the process for performing a business-to-business electronic auction of used vehicles using the World Wide Web in accordance with another aspect of an embodiment of the invention.

FIG. 4 is a block diagram of an embodiment of an electronic auction server system, a plurality of seller systems, and a plurality of buyer systems that support performing a business-to-business electronic auction of used vehicles over the Internet using the World Wide Web.

FIG. 5 is a flow diagram of an upload routine that enables verification, augmentation, and standardization of data regarding a used vehicle for presenting the vehicle to an electronic auction site using the electronic auction server system.

FIG. 6 is a flow diagram of a data feed routine for providing initial data regarding a specific used vehicle from a seller to the auction server system for use in an embodiment of the upload routine of FIG. 5.

FIG. 7 is a flow diagram of a VIN validation routine for use in an embodiment of the upload routine of FIG. 5.

FIG. 8 is a flow diagram of a data validation routine for use in an embodiment of the upload routine of FIG. 5.

FIG. 9 is a flow diagram of a standardization routine for use in an embodiment of the upload routine of FIG. 5.

FIG. 10 is a flow diagram of a valuation routine for use in an embodiment of the upload routine of FIG. 5.

FIG. 11 is a flow diagram of a transportation routine for use in an embodiment of a full-service business-to-business electronic auction of used vehicles over the Internet.

### DETAILED DESCRIPTION

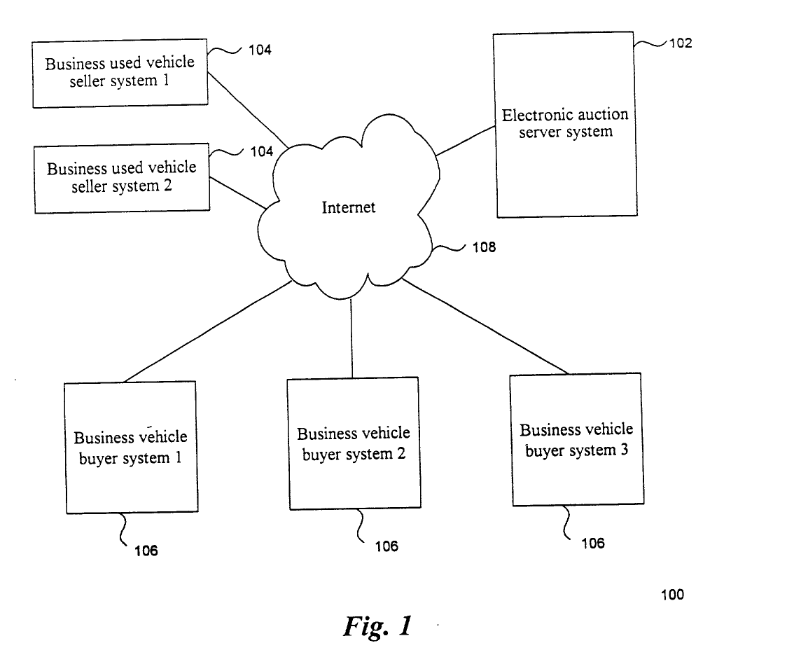

The following disclosure describes several methods and systems that facilitate business-to-business electronic auctions for wholesaling used vehicles over the Internet using the WWW. FIG. 1, for example, is a schematic illustration of an arrangement using an embodiment of the invention that supports a business-to-business electronic auction of used vehicles over the WWW. In this embodiment, the arrangement includes an electronic auction server system 102, a plurality of seller systems 104, and a plurality of buyer systems 106. The electronic auction server system, the seller systems, and the buyer systems can be coupled to the Internet 108 to facilitate communication between the systems. As explained in more detail below, these systems can also be coupled to one another using other techniques.

The parties involved in a business-to-business electronic auction for used vehicles over the Internet generally include an electronic auctioneer that operates the electronic auction server system, at least one seller of used vehicles that uses a seller system, and at least one buyer of used vehicles that uses a buyer system. In a typical application, the sellers include lending institutions, rental car companies, and companies or government agencies that operate large fleets of vehicles. The buyers are typically automobile dealerships that in turn sell the cars to individuals or small businesses in the retail market. Several embodiments of the business-to-business electronic auctions of used vehicles described below provide a system in which buyers and sellers can purchase used, relatively expensive cars and trucks without having to physically move the merchandise to a physical auction site. It is generally difficult to auction used vehicles over the Internet because (a) buyers want to inspect the vehicles, (b) buyers are leery of fraudulent activity, and (c) neither the buyers nor the sellers can easily arrange for transportation of the vehicles and payment. Moreover, the buyers in a business-to-business auction of used vehicles are generally automobile dealerships that buy several vehicles at an auction, and it is necessary that they become repeat customers to have a viable auction site. Thus, to successfully operate such a business-to-business electronic auction for used vehicles, the electronic auctioneer should (a) ensure that the information regarding the used vehicles is valid, (b) present the information in a consistent format, (c) establish an accurate wholesale value for the used vehicles, (d) arrange for the transportation of the vehicles, and (e) handle the financial exchange between the buyers and the sellers.

One aspect of providing an electronic auction for used vehicles is preparing data-records for the used vehicles for uploading to an electronic auction by validating the initial data provided by the seller and standardizing the nomenclature of the data. Another aspect of several embodiments of the invention is preparing data-records by mapping the validated and standardized nomenclature for a specific vehicle to various valuation services to provide at least one independent valuation of the vehicle that accurately reflects the make, model, and components or features of the specific vehicle. Several embodiments of the invention prepare accurate valuations for the vehicles because the auction server system collects the initial data to completely reflect all of the features of a vehicle. For example, when a seller inadvertently fails to include an option in the initial data regarding a vehicle, the data validation process adds the option from the reference data and uses the more complete data-record to valuate the car so that the seller receives the full value for the car. Also, by using data with standardized nomenclature, the auction server system can readily provide valuations from different valuation services that do not use consistent terminology. Thus, the auction server system can provide accurate valuations from a number of different valuation services so that neither the seller nor the buyer need to independently obtain valuations for the vehicle.

Another aspect of several embodiments of the present invention is to provide a full-service auction in which the electronic auctioneer arranges for transporting the vehicles from the sellers to the buyer. The electronic auctioneer can determine the approximate costs to ship a vehicle from one region to another and store the transportation costs in a transportation database. During an auction, the auction server system can provide a transportation fee to a buyer system for a selected vehicle by knowing the location of the vehicle from the seller and the desired shipping location for the buyer. The auction server system, for example, can provide the transportation fee as part of a vehicle description sent in response to a request from the buyer system. If the buyer wins the auction, the electronic auctioneer is then responsible for arranging and paying for the transportation of the vehicle. The electronic auctioneer, therefore relieves the buyers and sellers of the burden of arranging for the transportation of individual vehicles from a variety of locations and assumes the risk for cost overruns to transport a vehicle.

A. General Overview of an Embodiment of a Business-To-Business Electronic Auction of Used Vehicles

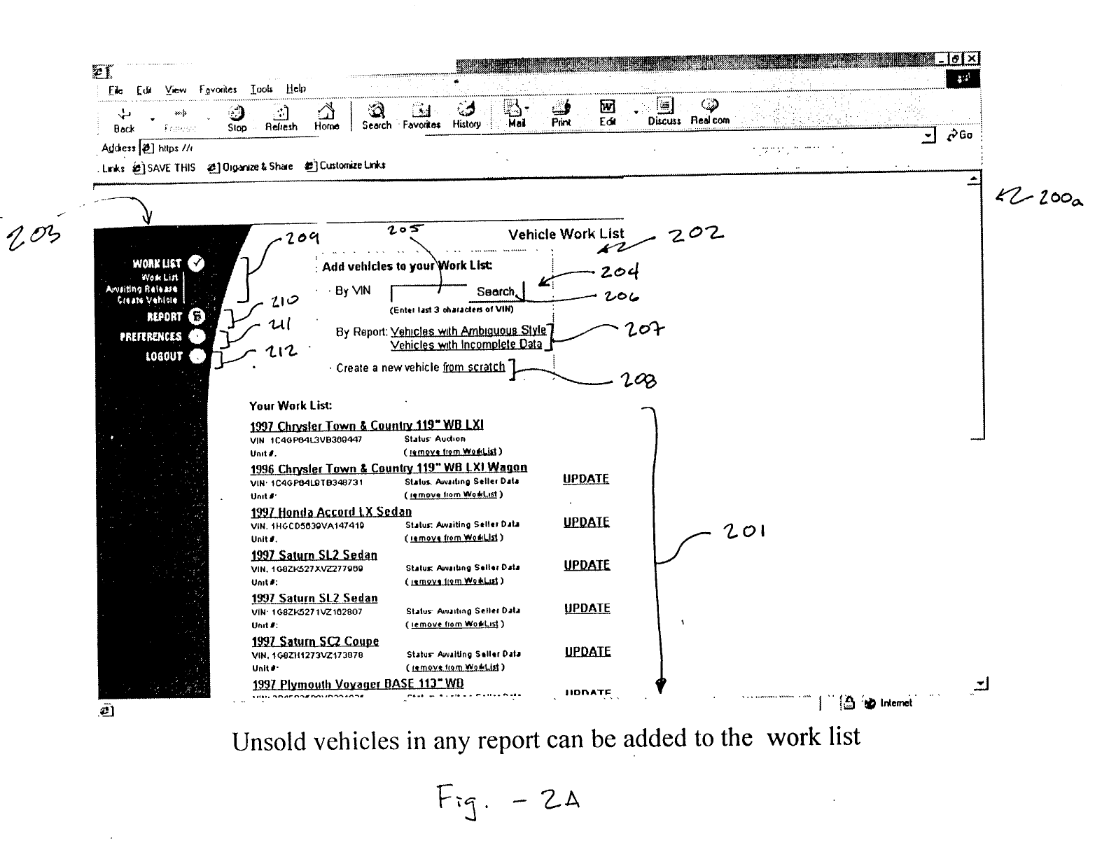

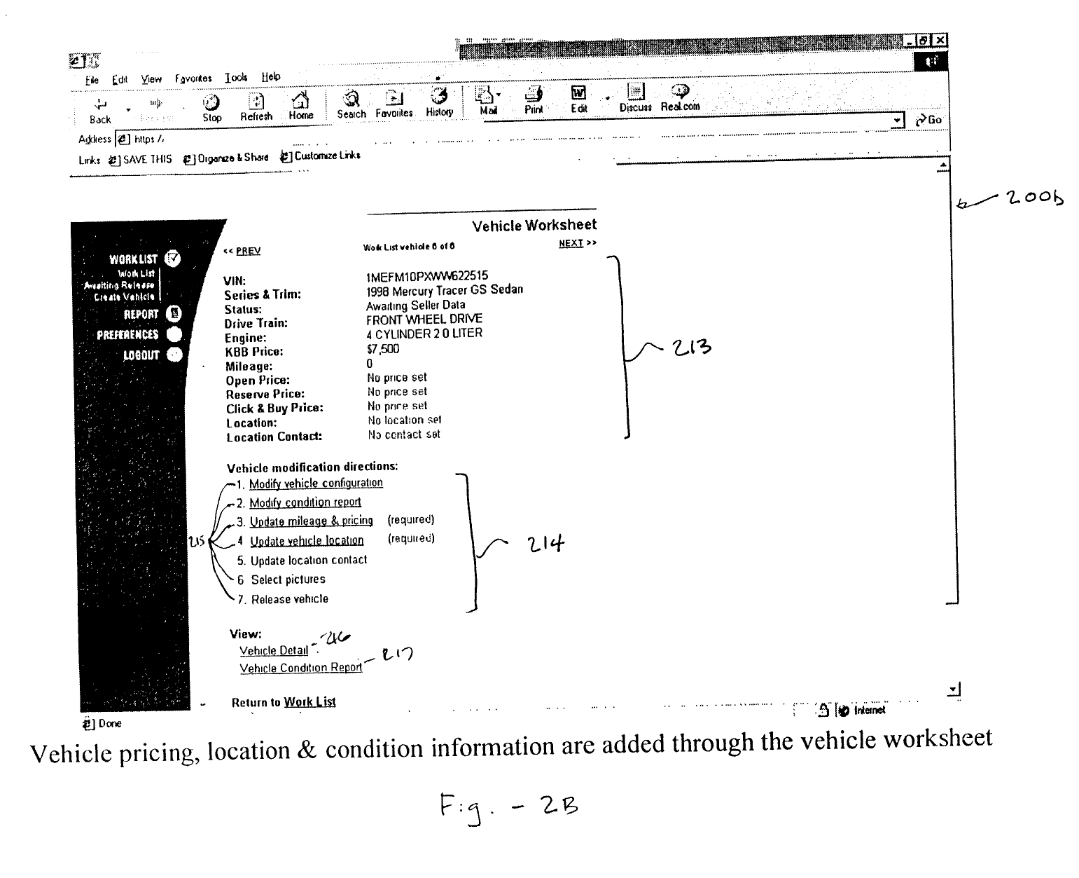

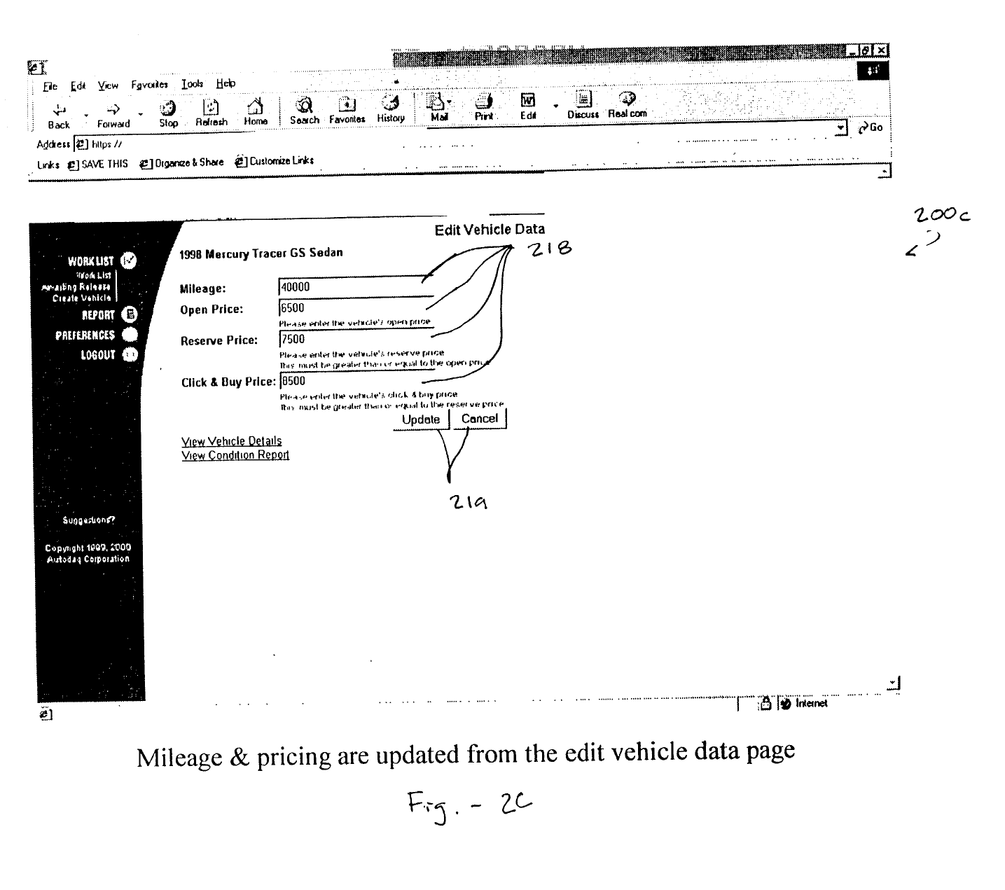

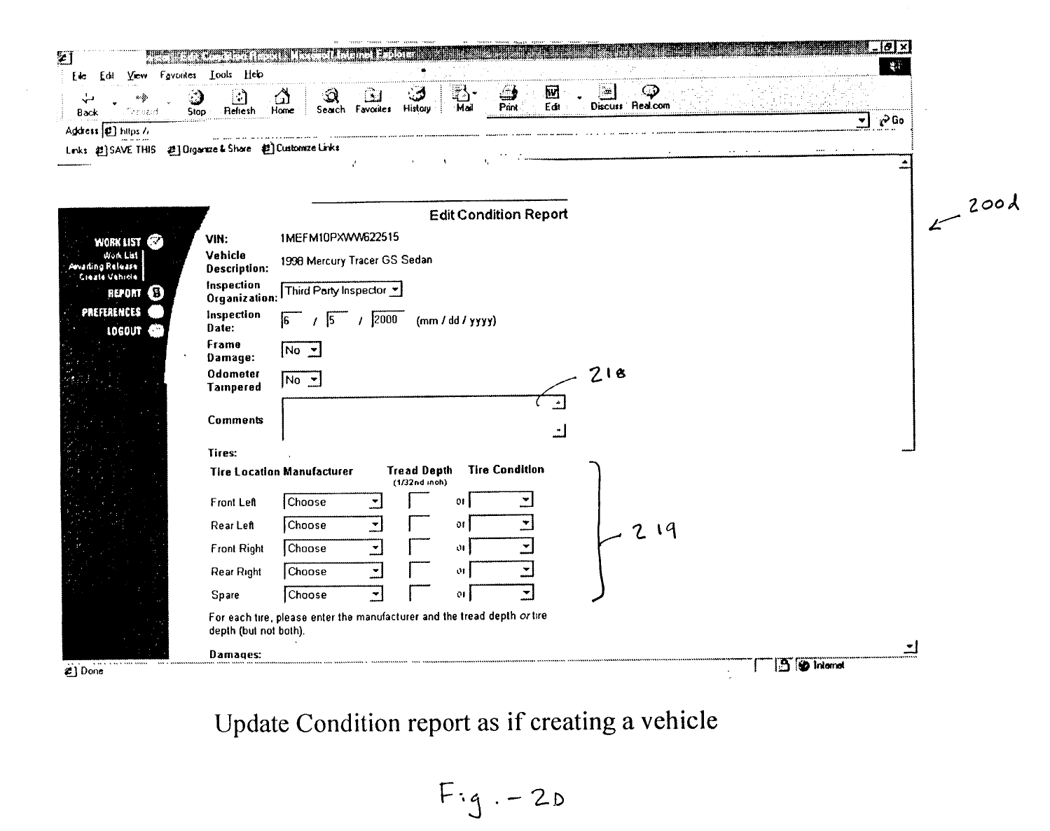

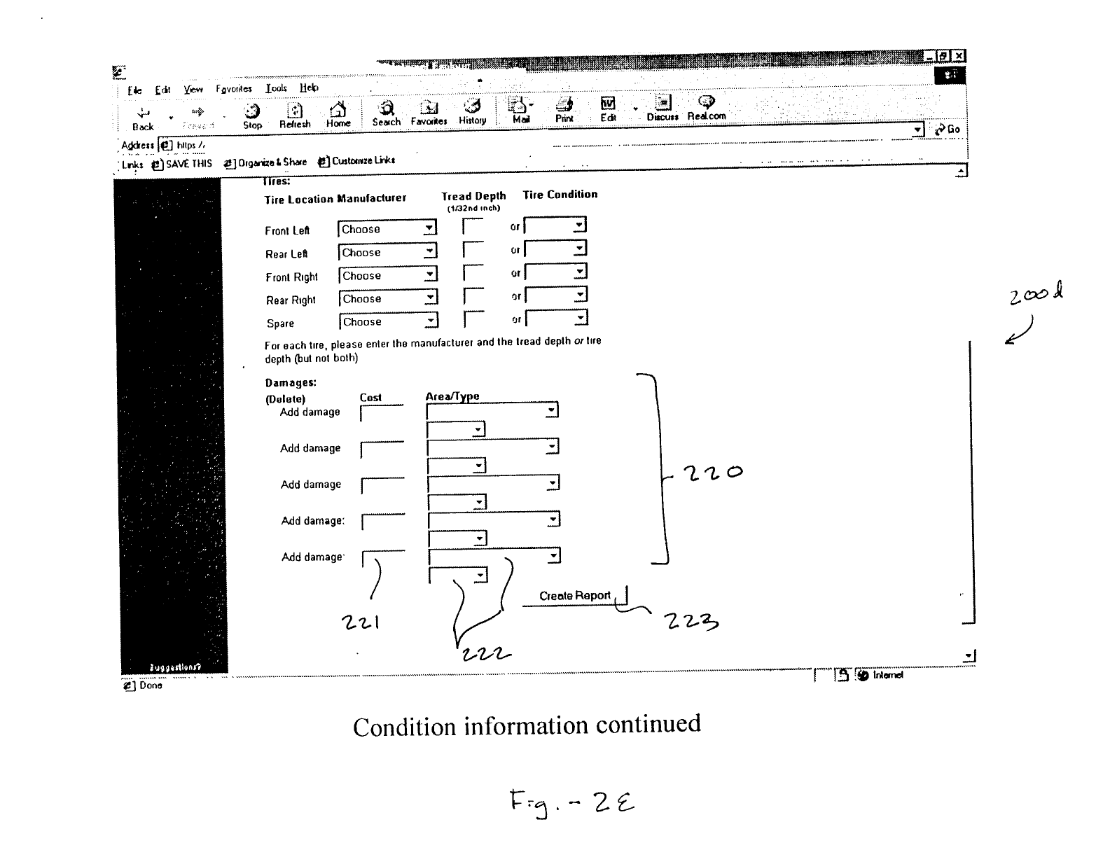

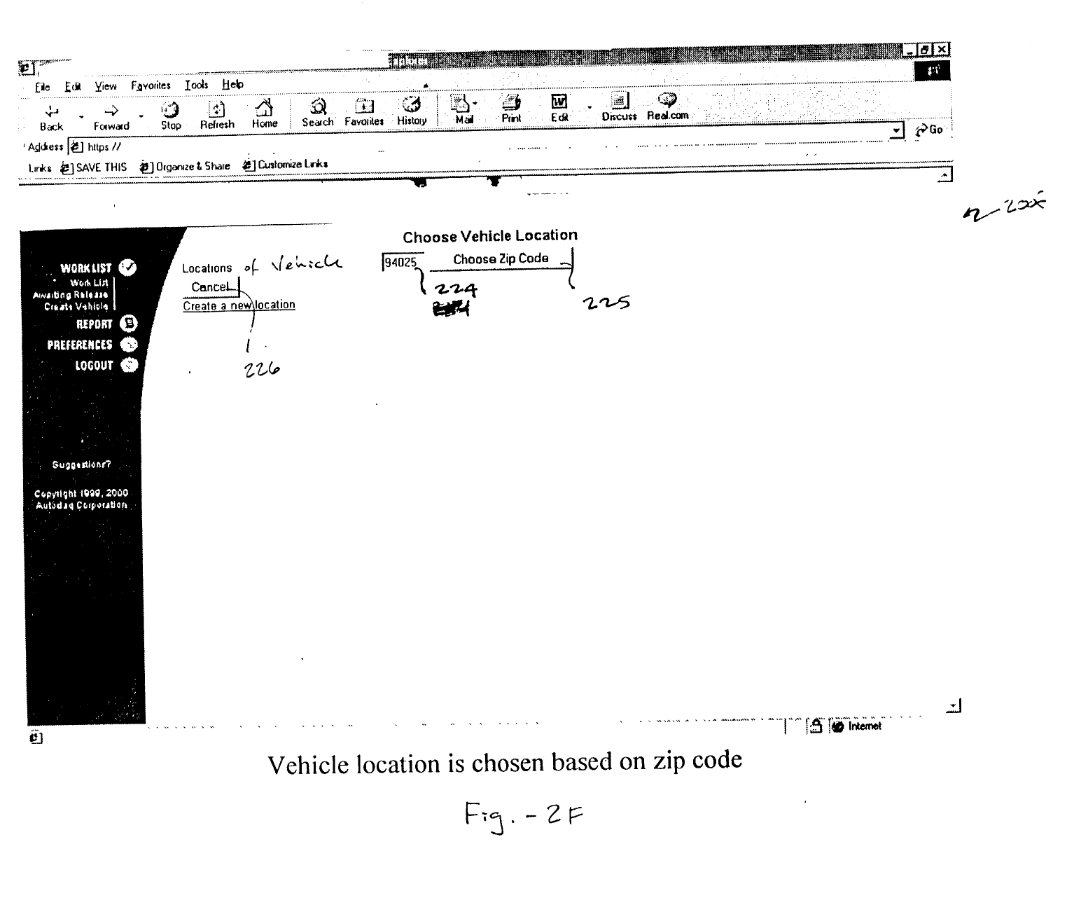

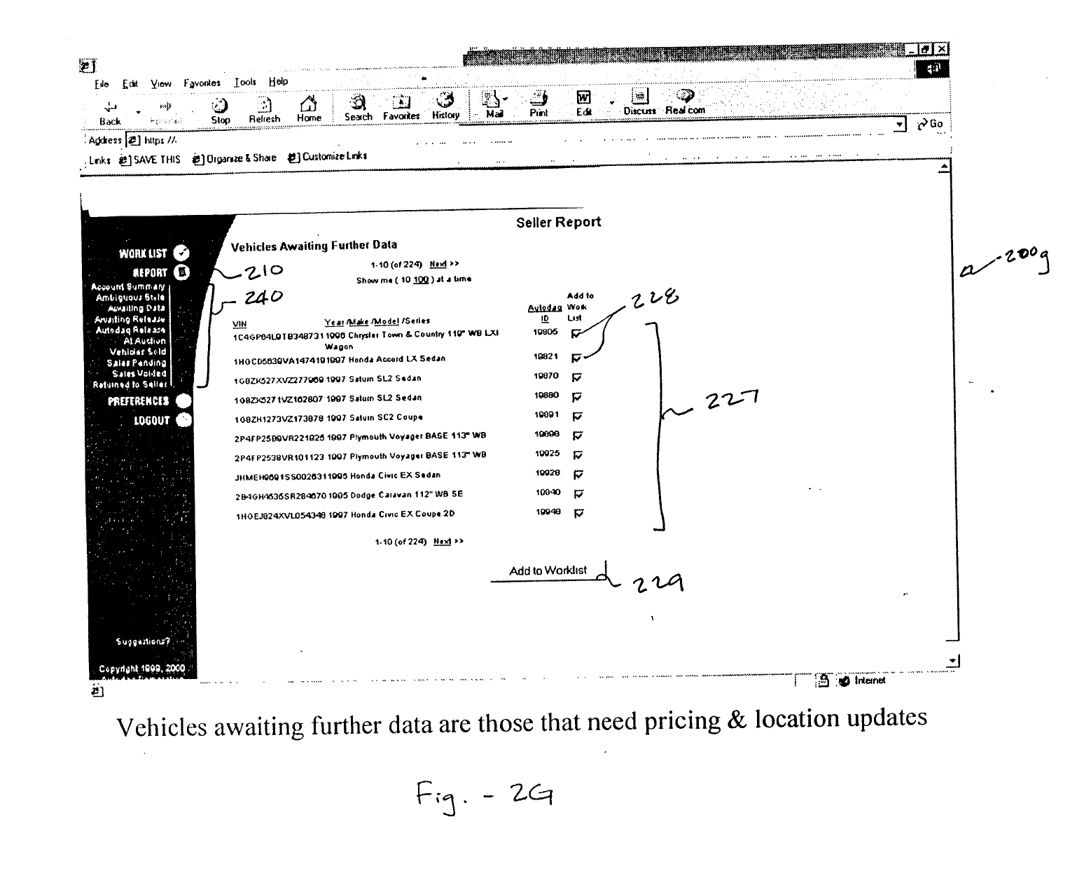

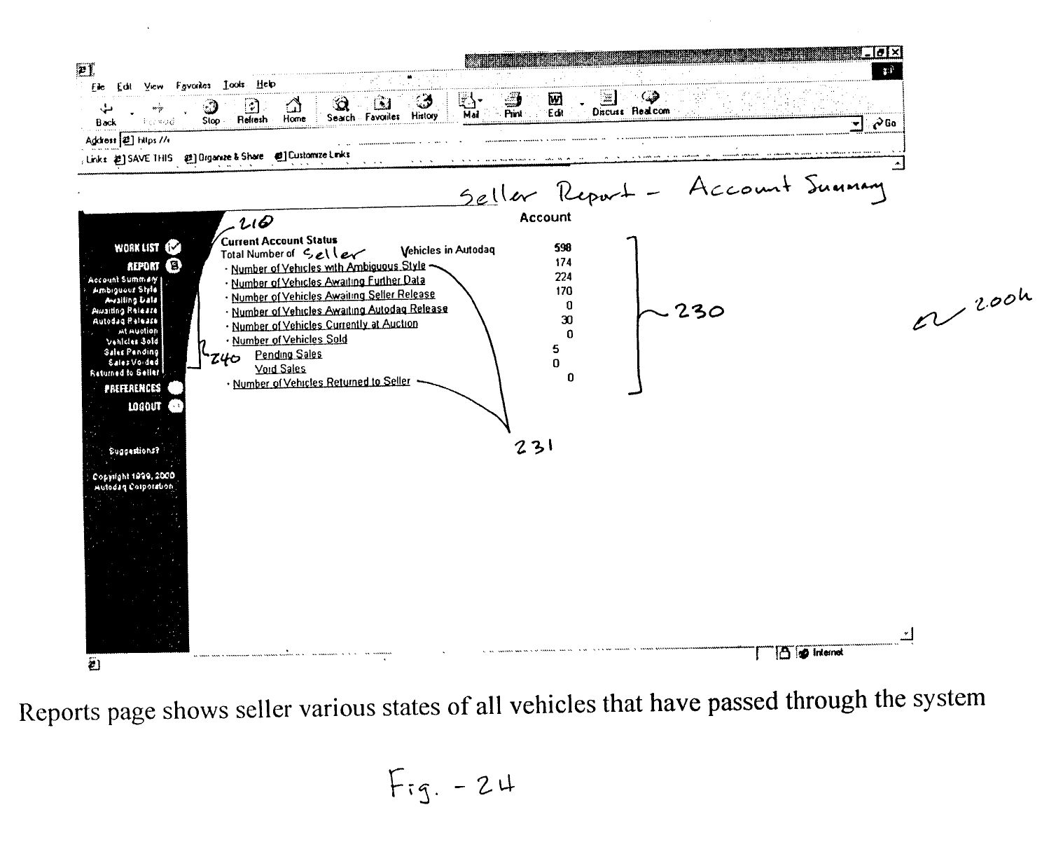

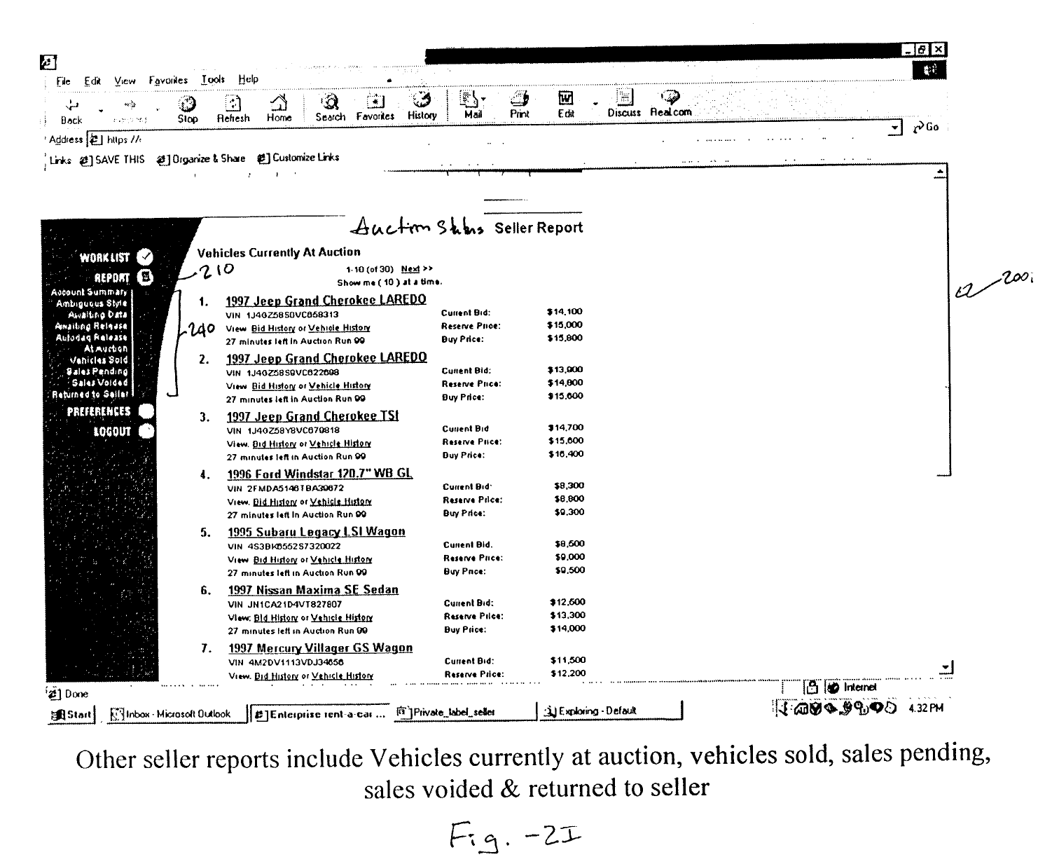

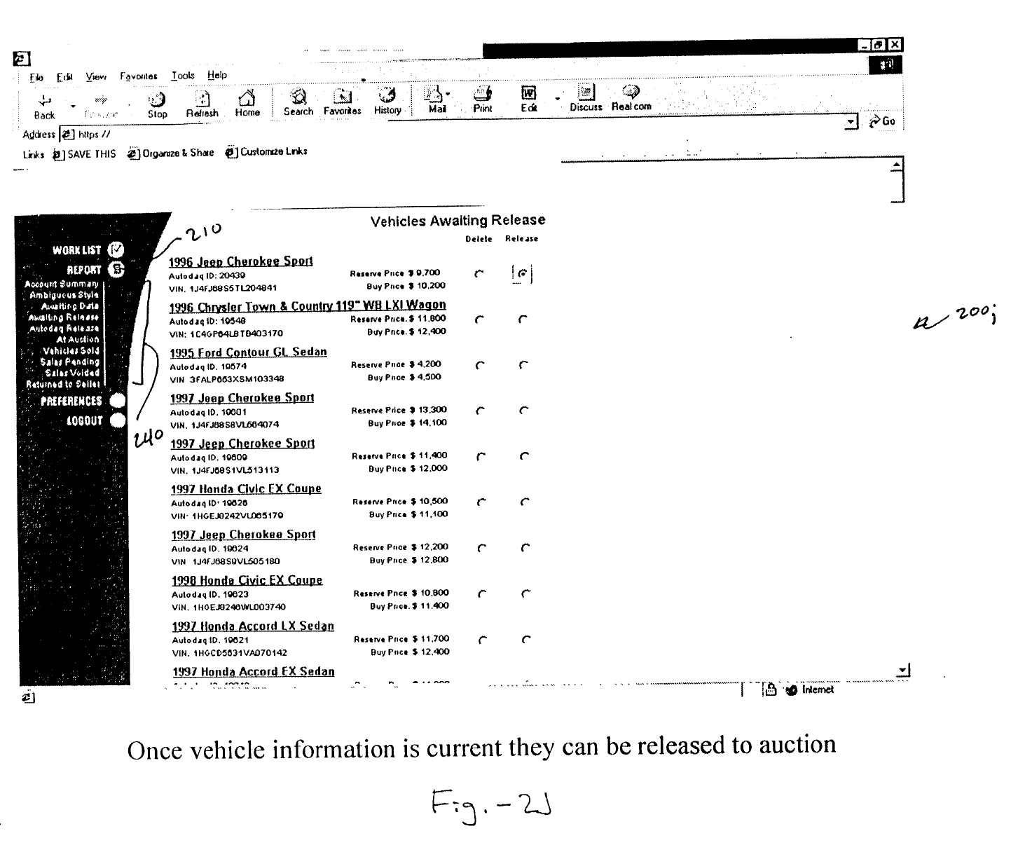

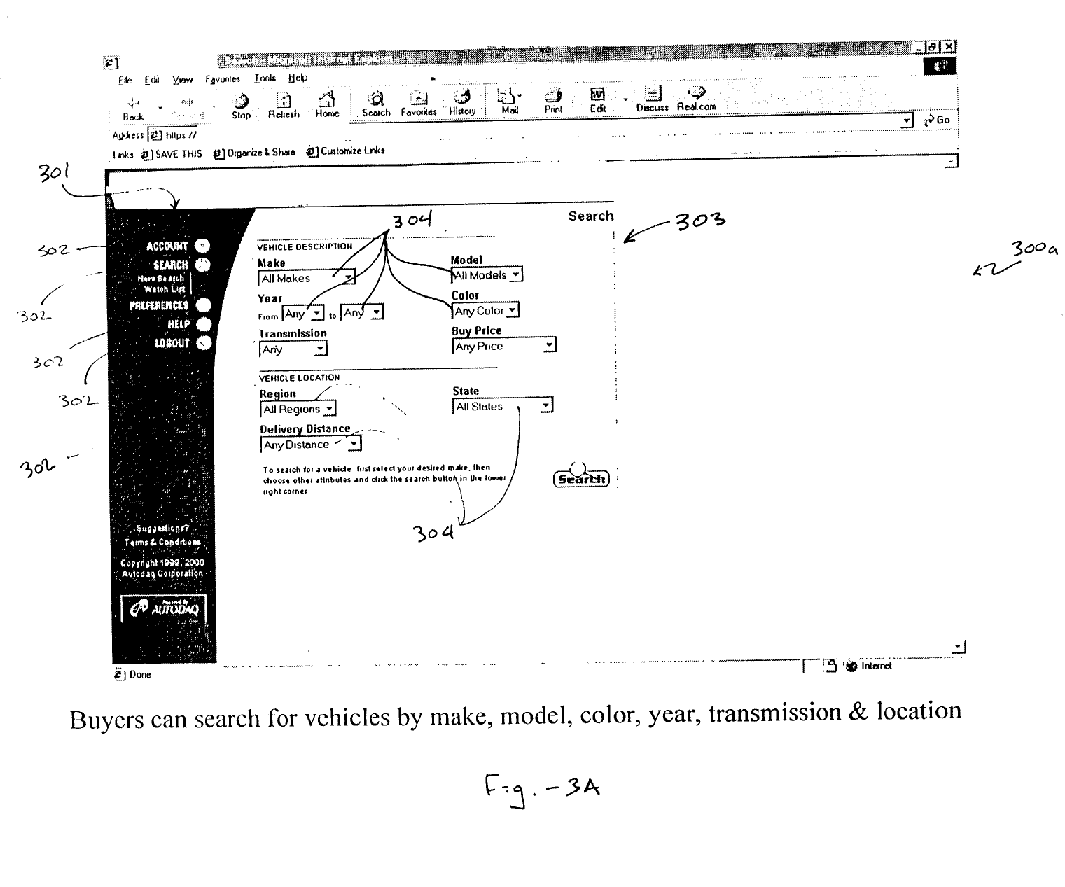

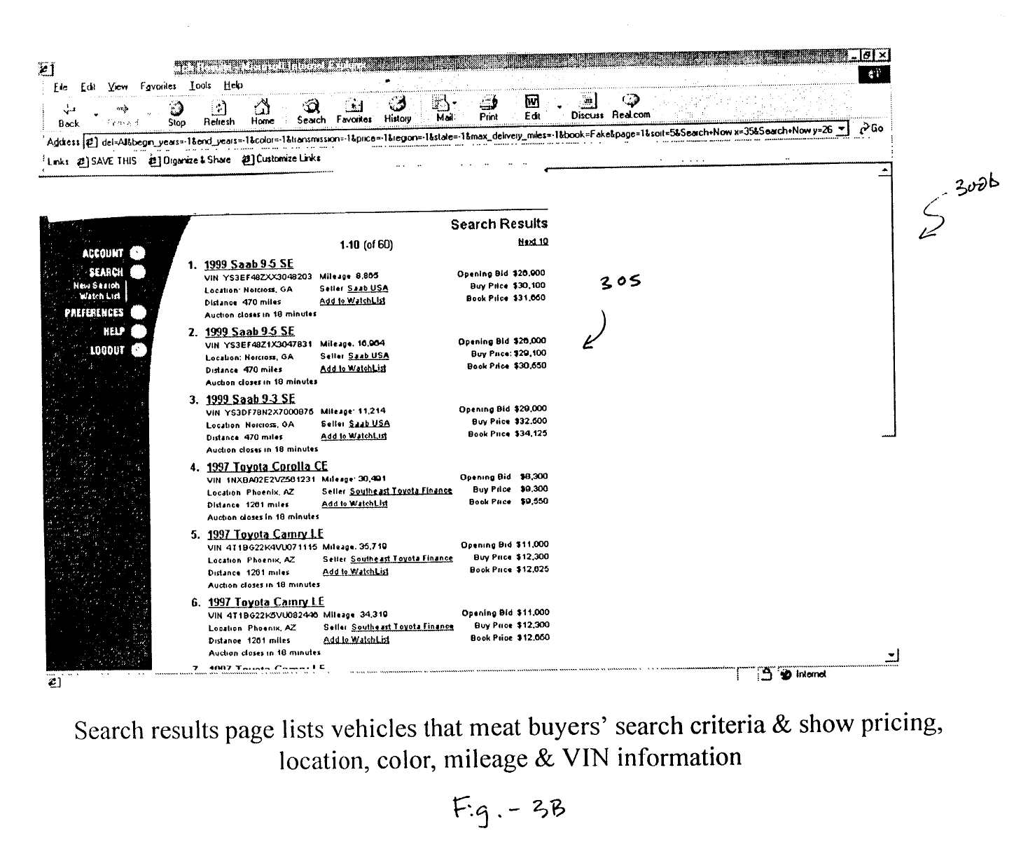

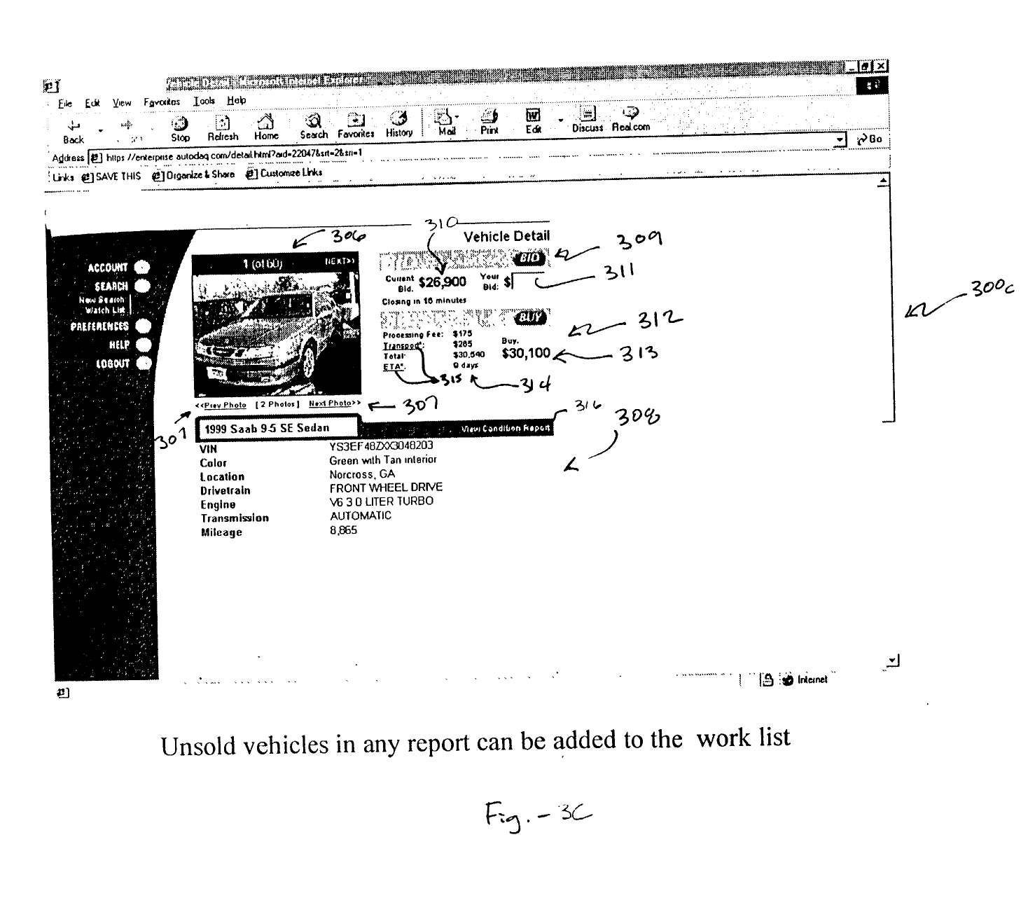

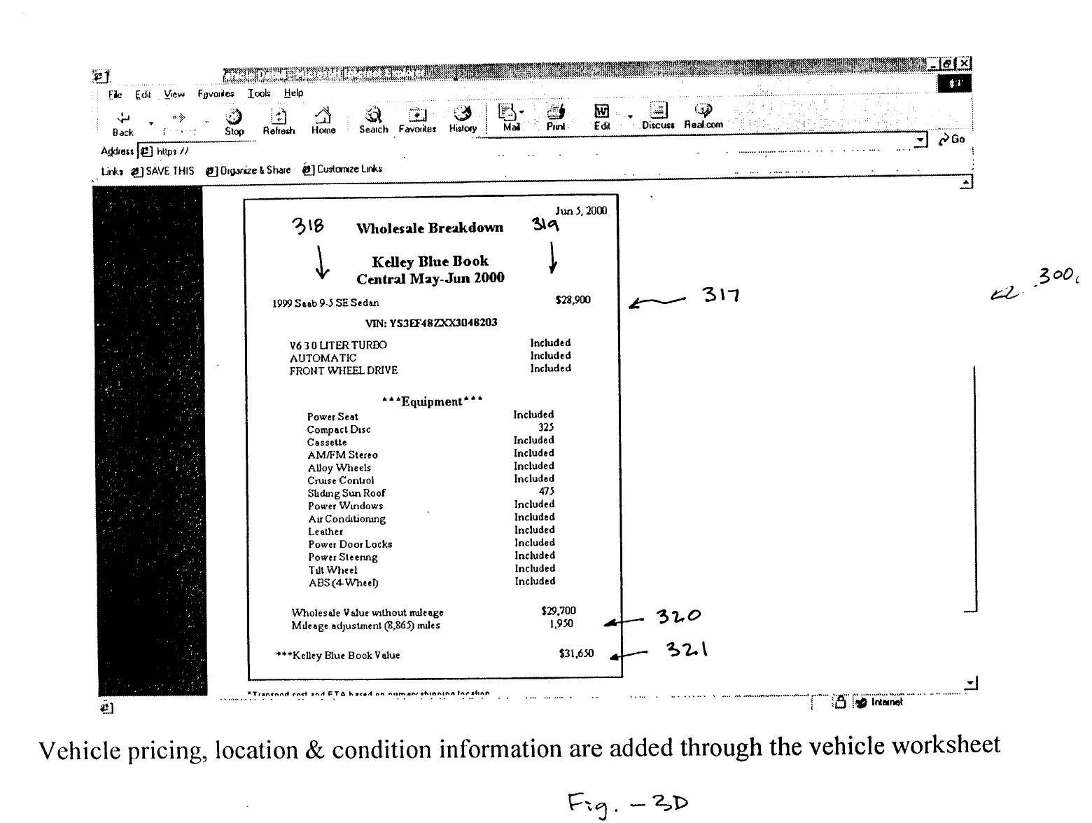

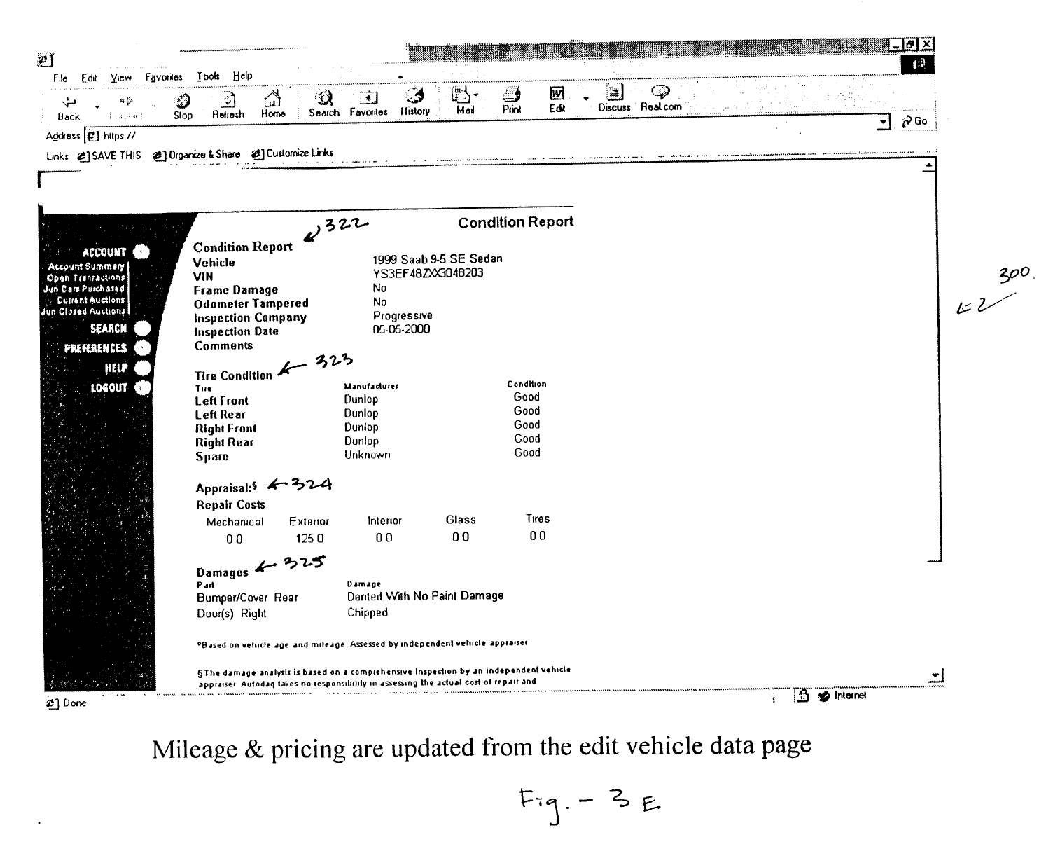

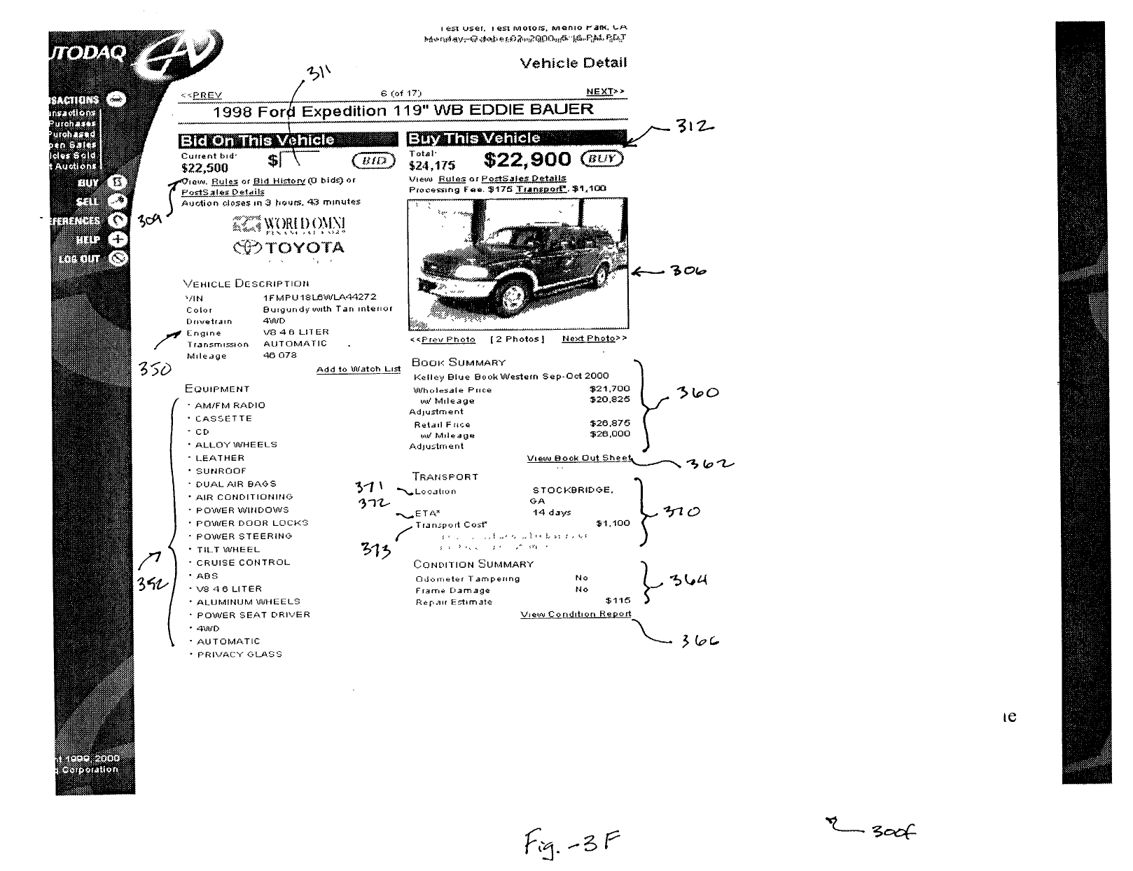

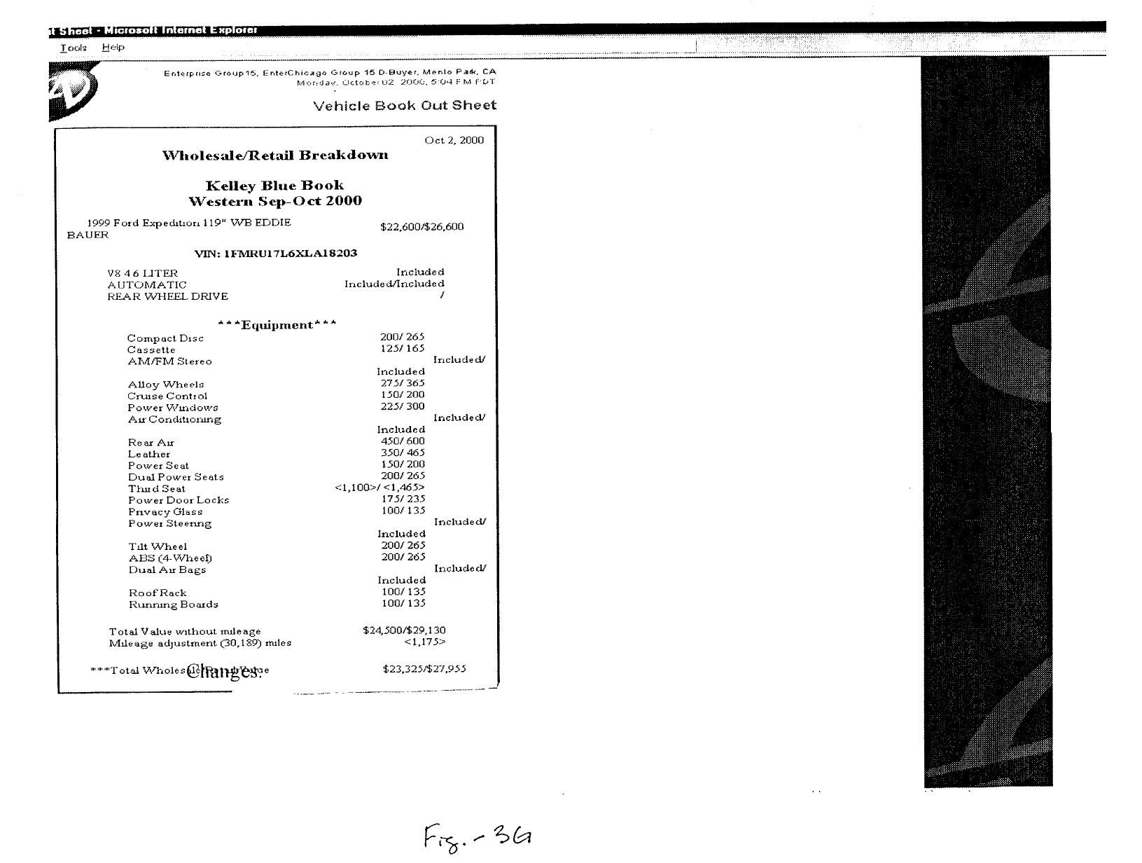

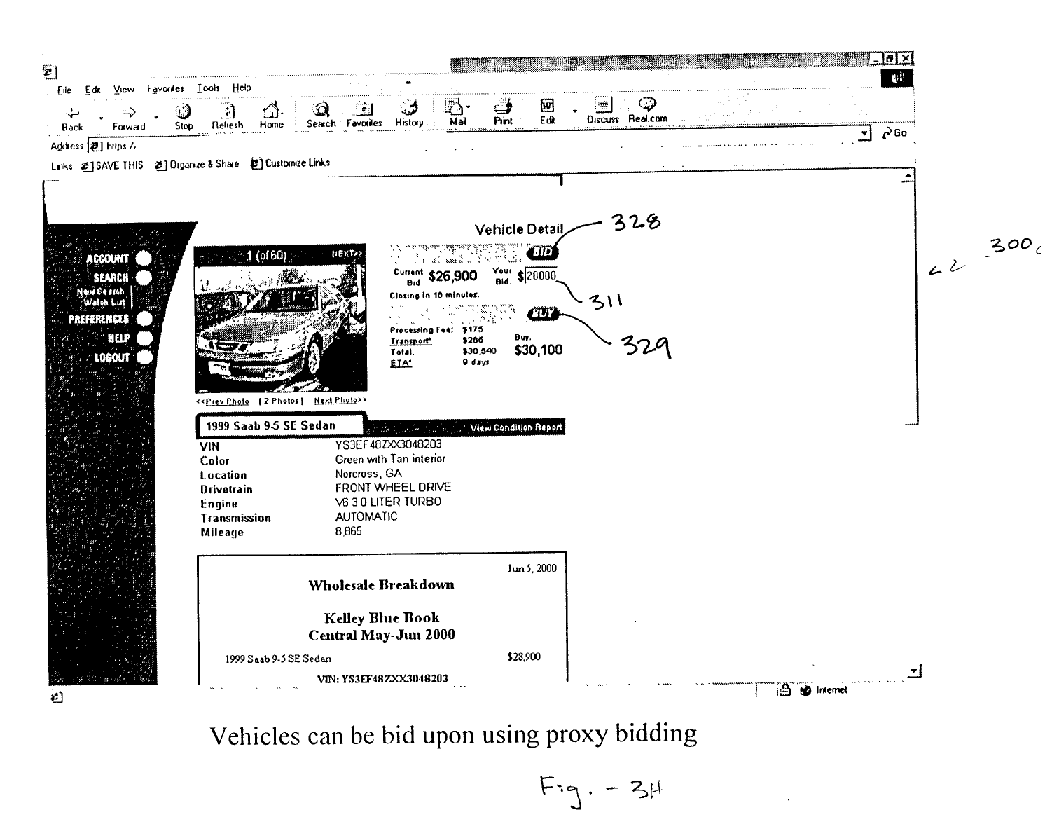

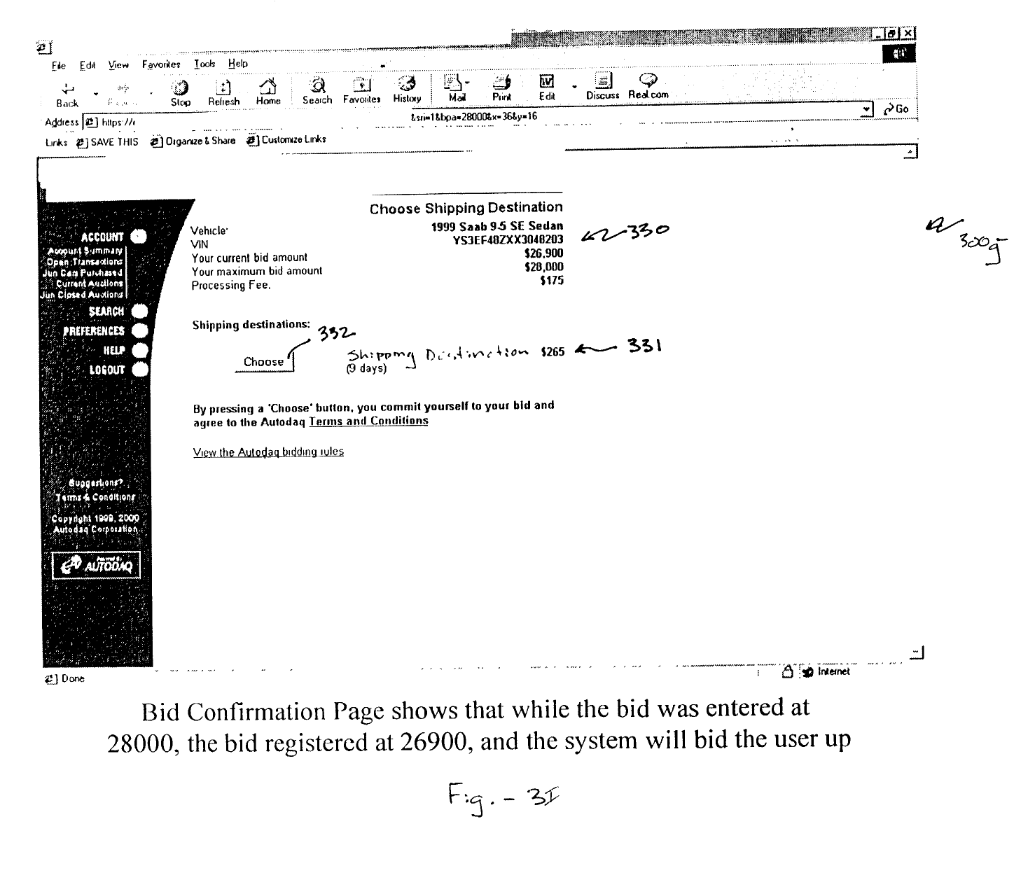

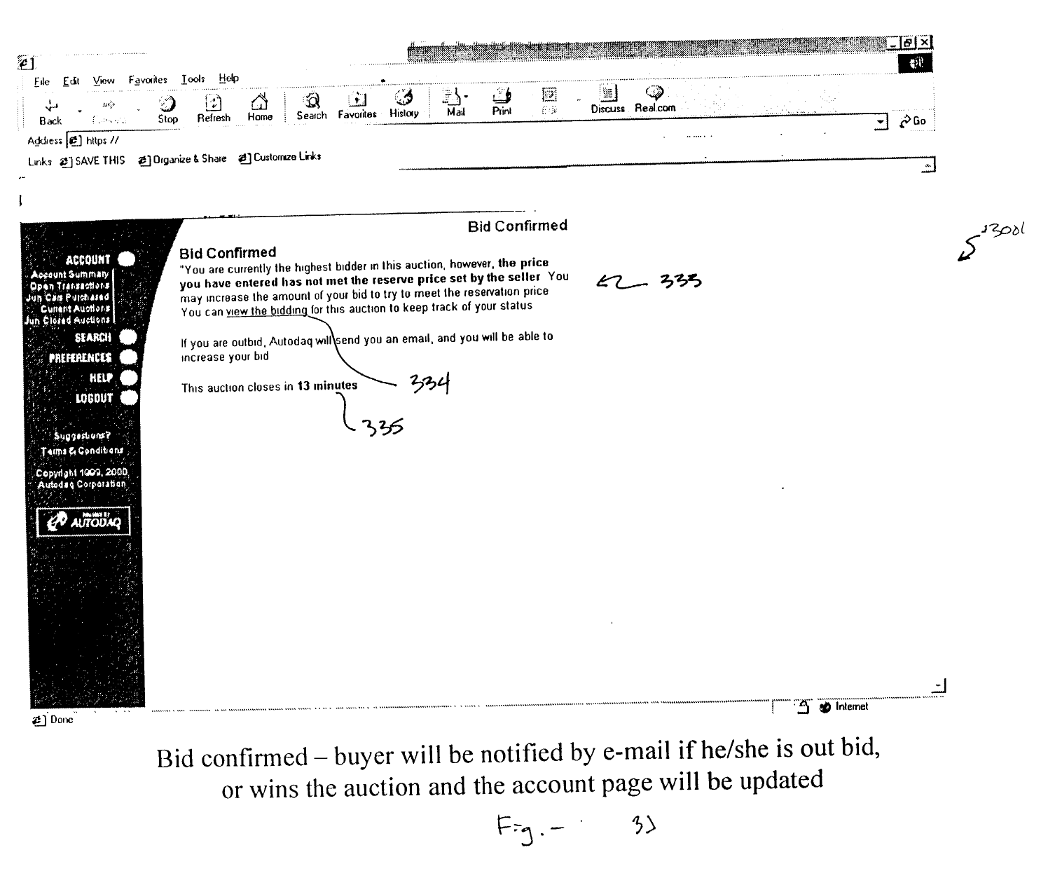

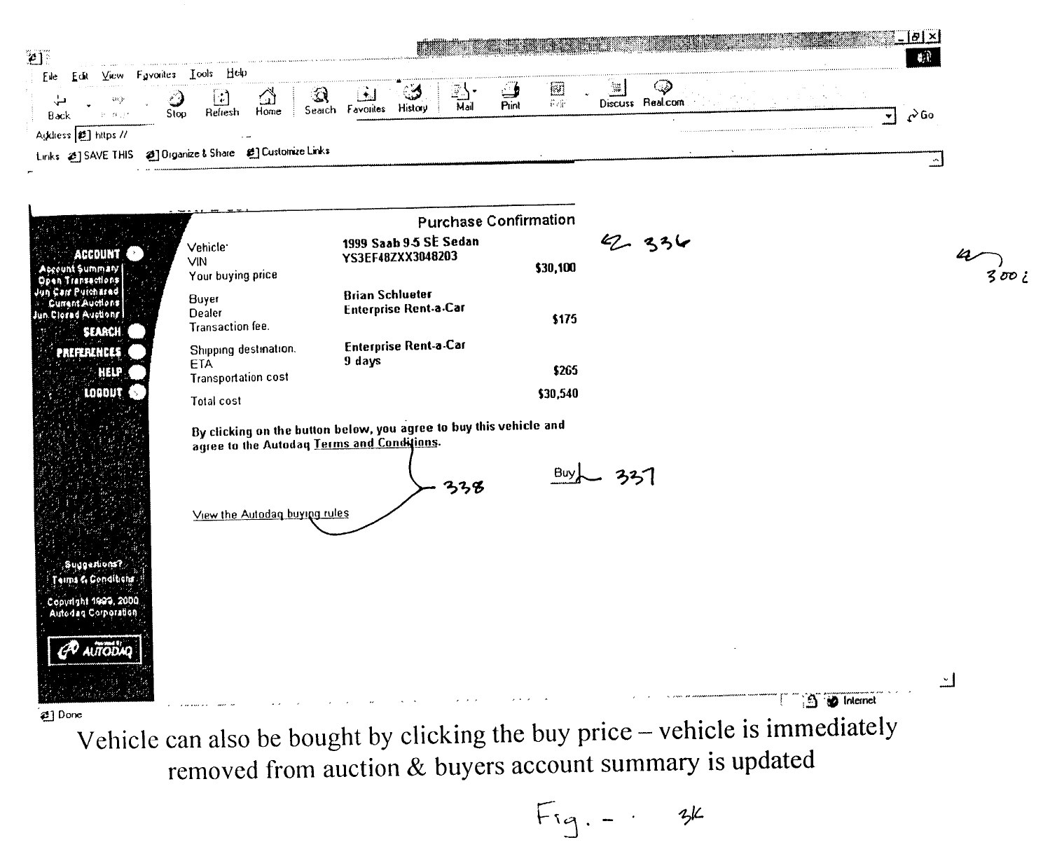

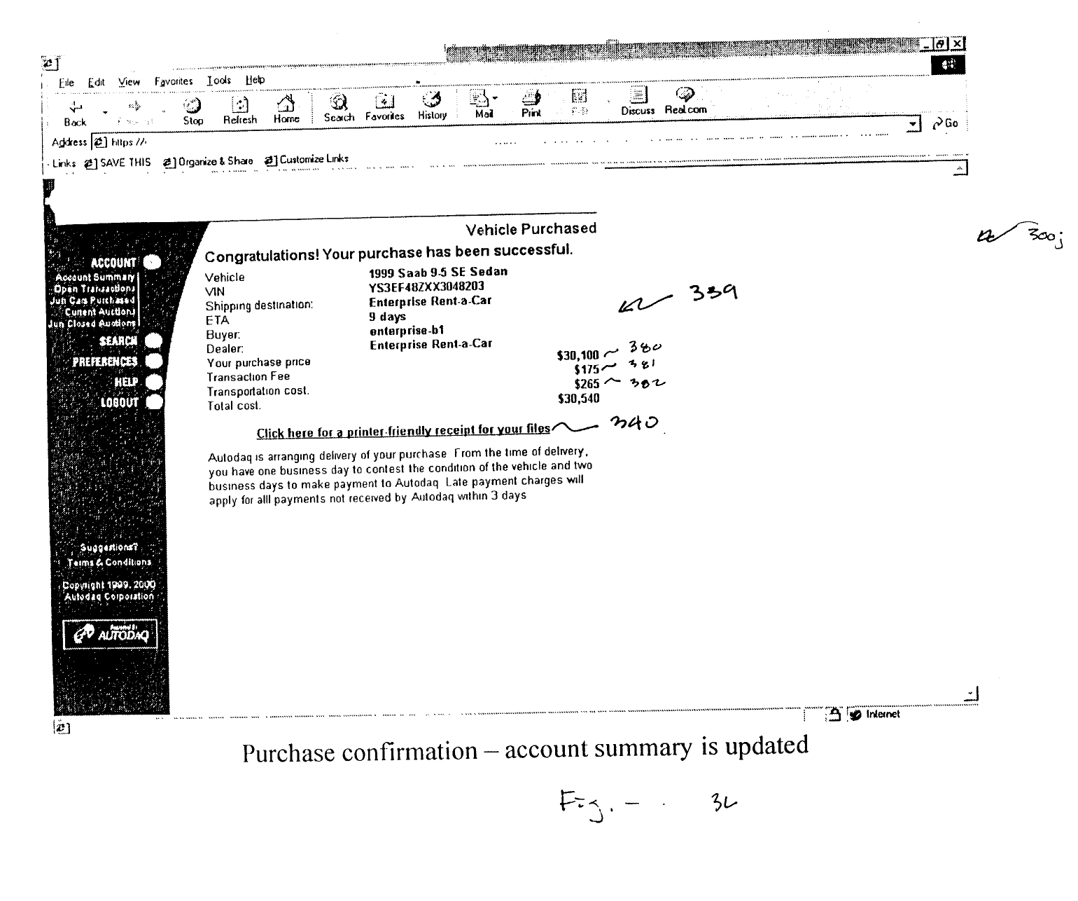

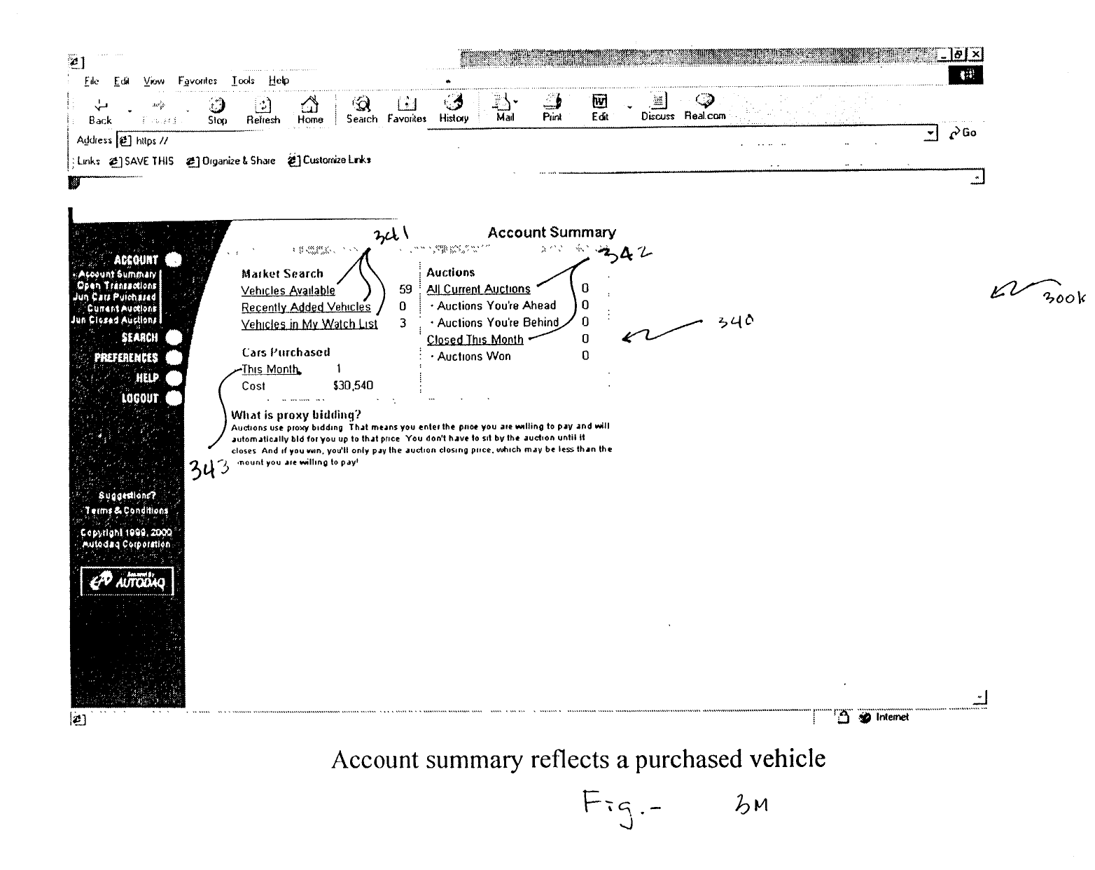

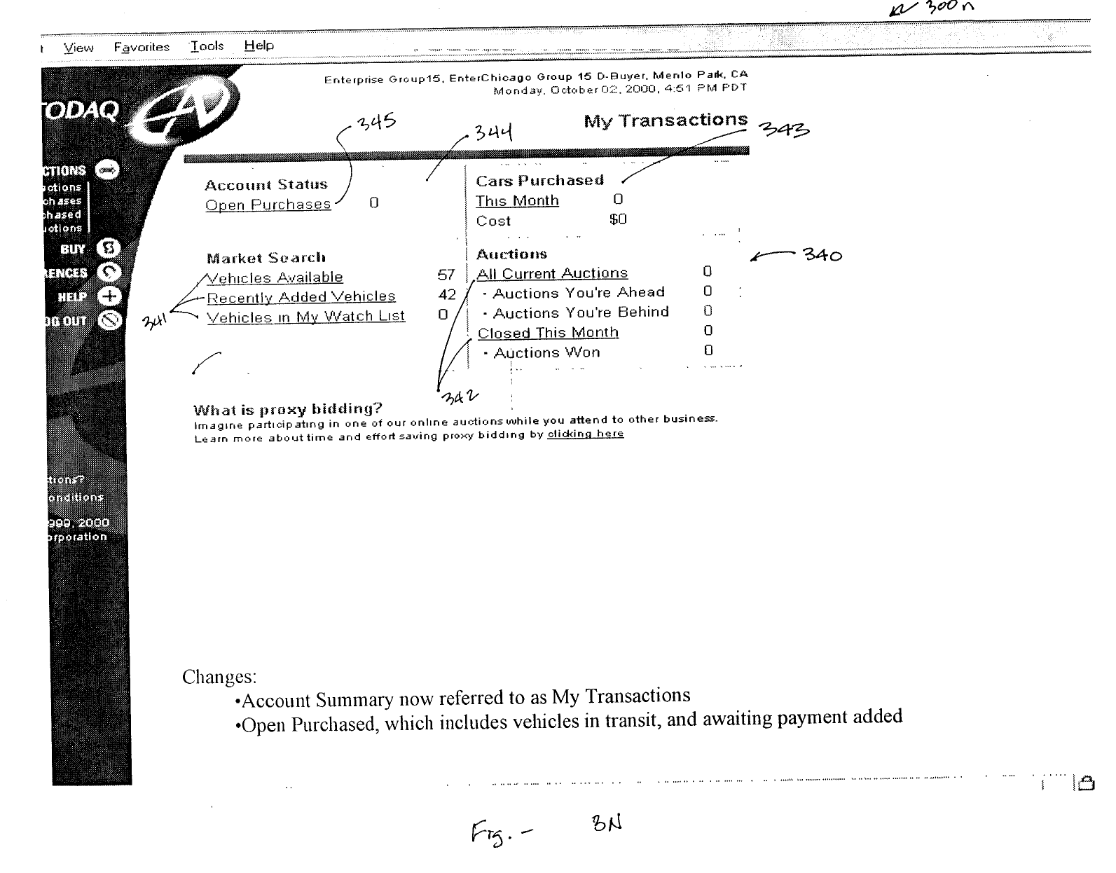

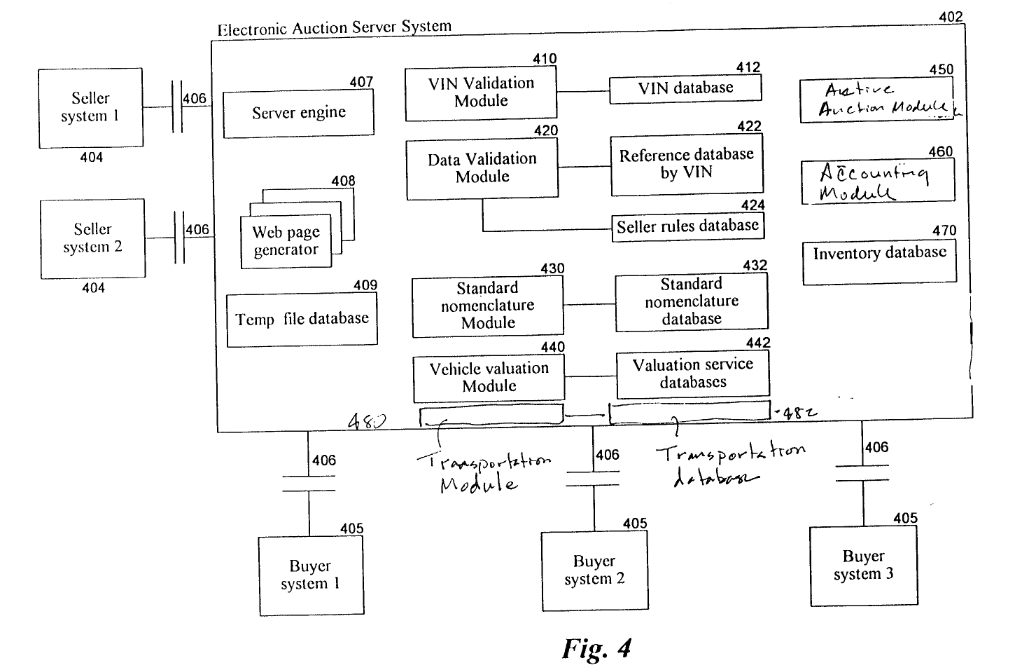

FIGS. 2A-2J illustrate an embodiment of a procedure for sellers to add and track vehicles on an auction database, and FIGS. 3A-3N illustrate an embodiment of a procedure for buyers to participate in an electronic auction for used vehicles. In general, the web pages illustrated in FIGS. 2A-2J and 3A-3N are generated and sent by the auction server system in response to requests (e.g., HTTP requests) from the seller systems (FIGS. 2A-2J) or the buyer systems (FIGS. 3A-3N). The process of selling used vehicles using an electronic auction initially involves communications between the sellers and the electronic auctioneer (e.g., via the seller systems and the auction server system). Accordingly, the following description will initially describe an embodiment for a seller to track a vehicle through an electronic auction.

1. Seller Transaction for a Business-To-Business Electronic Auction of Used Vehicles

FIG. 2A illustrates a seller work-list web page 200a displayed at a seller system. The work-list page 200a was sent from the auction server system 102 in response to a request from a seller system to (a) add a vehicle to the auction, (b) edit the data regarding a vehicle that the seller has already added to the database of the electronic auction server system, and/or (c) review the inventory of the seller's vehicles in the auction server system. The work-list page 200a can contain a list 201 of the vehicles owned by the seller that are in the vehicle database of the auction server system, an input section 202, and a menu 203. The input section 202 can include a search tool 204 having an input field 205 and a button 206 to search for vehicles in the list 201 by the Vehicle Identification Number (“VIN”). The search tool can alternatively use other criteria to search for vehicles in addition to or in lieu of the VIN. The input section 202 can also include a plurality of links 207 that search for vehicles according to the status of the data, such as vehicles for which the database includes incomplete data or vehicles for which the data is ambiguous. The input section 202 can also include a link to create a record for a new vehicle to be added to the list 201.

The menu 203 can include a number of work list links 209 to link to various web pages for viewing or inputting data for the vehicle work list, report links 210, preference links 211, and a logout link 212. The work list links 209 generally request web pages from the auction server system regarding inputting data or reviewing data for used vehicles on the seller's work list. The report links 210 provide requests for various reports, and the preference links 211 set particular preferences for an auction. It will be appreciated that the work list, reports and preferences are generally specific to each seller. As such, the auction server system generally uses a password system to protect the confidentiality and integrity of the data entered by the various sellers.

FIG. 2B illustrates an example of a vehicle worksheet page 200b to modify data for a vehicle that was already on the list 201 of the work-list page 200a. The vehicle worksheet 200b can also be similar to a worksheet for creating a record for a new vehicle to be added to the list 201. The embodiment of the vehicle worksheet 200b shown in FIG. 2B includes a status field 213 showing the data in the auction server system regarding a specific vehicle and the status of the data-record for that specific vehicle. In this specific embodiment, the status indicates that the auction server system is “awaiting seller data.” The vehicle worksheet 200b can also include a data input section 214 having a number of links 215 for modifying or inputting data regarding the specific vehicle, a link 216 for viewing the vehicle detail, and a link 217 for viewing a condition report on the vehicle. The links 215 can include required fields, such as updating the mileage, pricing and vehicle location. The links 215 can also include optional links for modifying the vehicle configuration, modifying a condition report on the vehicle, selecting pictures for the vehicle, and releasing the vehicle for the auction. When the auction server system is awaiting additional data to further process a vehicle, the seller can select the particular links to input the additional data into the auction server system.

FIGS. 2C-2F illustrate various pages for entering and/or editing data regarding a specific vehicle. FIG. 2C, more specifically, illustrates a vehicle data page 200c for entering some of the required data from the links 215 of the vehicle worksheet 200b (FIG. 2B). The vehicle data page 200c can include a number of input fields 218 for inputting data and a number of buttons 219 to select either updating the data-record for the specific vehicle or canceling the data update. The vehicle data page 200c can also include other links or additional input fields.

FIGS. 2D and 2E illustrate a condition report page 200d that identifies the specific data in the database of the auction server system for a vehicle and provides a plurality of additional fields for inputting data regarding the condition of the vehicle. The additional input fields for the condition report 200d can include a general field 218 for entering general comments, a tire condition field 219 for entering the specific condition of the tires, and damage input fields 220 (FIG. 2E) for identifying any damage on the vehicle. The tire input fields 219 can include pull-down menus for selecting the particular manufacturer and model of each tire, along with the condition of each tire. The damage-input fields 220 can include separate cost estimation fields 221 and description fields 222. The seller can input the estimated cost of the damage for each area and type of damage indicated in the input fields 221 and 222. Additionally, the description input fields 222 can further include pull-down menus that use standardized nomenclature for identifying the particular areas on vehicles and the particular type of damage. The condition report 200d can also include a button 223 for adding the data in the fields 218-220 to a data-record for the vehicle in the auction server system. More specifically, when the seller actuates the button 223, the seller system sends the data entered in the fields 218-220 to a database in the auction server system (e.g., a temporary file database).

FIG. 2F illustrates a vehicle location page 200f having a field 224 for entering the current location of a vehicle. The vehicle location page 200f can also include a button 225 for entering the zip code into the field 224 and a button 226 for canceling the zip code. When the seller actuates the button 225, the seller system sends the input zip code to a database of the auction server system.

FIGS. 2G-2J illustrate various seller report pages 200g-200j that are generated by the auction server system 102 and sent to the seller system 104. FIG. 2G illustrates a seller report page 200g identifying vehicles awaiting further data to be input by the seller. This embodiment of the seller report page 200g includes a list 227 of vehicles awaiting further data, a plurality of fields 228 for adding specific vehicles to the seller's work list, and a button 229 for adding the vehicles that have a checkmark in the fields 228. The seller report page 200g can also include a plurality of individual report links 240 for requesting other types of reports from the auction server system. The individual report links 240 can be accessed by selecting the primary report link 210.

FIG. 2H illustrates an embodiment of an account summary report 200h having a list 230 identifying the number of vehicles in the database of the auction server system for a particular seller and a plurality of links 231 for requesting web pages regarding specific categories of vehicles. The links 231 can include a link for the number of vehicles with ambiguous styles (e.g., ambiguous nomenclature), a link for the number of vehicles awaiting further data, a link for the number of vehicles awaiting seller release, a link for the number of vehicles awaiting release by the auctioneer to the auction, a link for the number of vehicles currently at auction, a link for the number of vehicles sold that are pending sales or in which sales have been voided, and a link for the number of vehicles returned to the seller. FIG. 21 illustrates an auction status report 200i listing the status of the vehicles owned by the seller that are currently being auctioned via the auction server system. FIG. 2J illustrates an embodiment of a pending release report 200j listing the vehicles for which the seller has input data to the auction server system but has not yet released to the electronic auction.

One concern of selling used vehicles at an electronic auction in a business-to-business application is that the data in a data-record for the specific vehicles must be accurate so that the buyers have confidence in the electronic auction. The auction server system should accordingly lead the seller to input accurate and sufficient data for creating a data-record that can be used to accurately present the vehicle at an electronic auction. The vehicle work list 200a (FIG. 2A) and the various web pages for entering data on a vehicle worksheet 200b (FIG. 2B) regarding a specific vehicle enable a seller to readily identify the vehicles that are in the process of being added to the database of the auction server system and any additional information that is needed to upload the vehicles to an auction. As such, several aspects of operating a business-to-business electronic auction for used vehicles in accordance with several embodiments of the invention involve validating the data entered by the seller, establishing a standardized nomenclature for the data, and providing pricing from different valuation services.

Another concern of operating a business-to-business electronic auction for used vehicles is providing the volume sellers with reports to (a) assist the sellers in accurately releasing vehicles for sale at the auction server system, and (b) providing information to the sellers for tracking the vehicles during an electronic auction. The seller report pages 200g, 200h and 200j provide the sellers individual reports so that they can monitor the status of the vehicles that require either additional data or clarification of ambiguous data. The seller report page 200i provides the sellers the status of the particular vehicles in an auction run. It will be appreciated that the reports illustrated in FIGS. 2G-2J are only examples of some embodiments of reports that can be provided to the sellers. As such, the auction server system can provide additional or different reports to sellers.

2. Buyer Transaction for a Business-To-Business Electronic Auction of Used Vehicles

FIGS. 3A-3N illustrate several embodiments of web pages generated by the auction server system for display at the buyer systems. FIGS. 3A and 3B specifically illustrate embodiments of web pages sent by the auction server system to a buyer system that enable a buyer to participate in an electronic auction. FIG. 3A illustrates an embodiment of a search page 300a that a buyer uses to search for vehicles by make, model, color, year, transmission, location and/or other criteria. This embodiment of the search page 300a includes a menu 301 having a plurality of primary links 302 that send requests from the buyer system to the auction server system for additional web pages regarding the buyer's account, additional searches, preferences of the buyer, electronic assistance from the auction server system, and logging out of the electronic auction. The search page 300a can also include a plurality of input fields 304 for entering search criteria. The input fields 304 can have pull-down menus to easily identify search criteria for the vehicle description (e.g., the vehicle make, model, year, color, transmission, buy prices, etc.), the vehicle location (e.g., region, state, and delivery distance), and other categories of search criteria. The vehicle location field allows the buyers to select cars from regions that do not wear vehicles under harsh conditions, or regions that are relatively close to the buyer to reduce transportation costs.

FIG. 3B illustrates an embodiment of a search result page 300b that lists the vehicles participating in the electronic auction that match the criteria entered by the buyer in the input fields 304 of the search page 300a (FIG. 3A). The search results page 300b is generated by the auction server system and displayed at the buyer system. The search results page 300b generally has a list 305 including the pricing, location, color, mileage, VIN information, and/or additional information for the vehicles that match the buyer's search criteria. It will be appreciated that the search page 300a and the search results page 300b can have different embodiments or be a different form of electronic communication (e.g., e-mail message). As such, the search page 300a and the search results page 300b can be any type of page or other communication that allows the buyer to search for vehicles according to particular criteria and review the status of the electronic auction for cars that match that criteria.

FIGS. 3C-3G illustrate embodiments of web pages generated by the auction server system for display at a buyer system to review and bid on a specific vehicle selected by the buyer. FIGS. 3C and 3D, more specifically, illustrate an embodiment of a detail page 300c containing information regarding a specific vehicle that the buyer received by selecting the specific vehicle from the list 305 on the search results page 300b (FIG. 3B). For example, by selecting the link for the 1999 Saab 9-5SE shown in the list 305, the buyer system sends a request to the auction server system to display the detail page 300c shown in FIG. 3C regarding the Saab 9-5SE. The detail page 300c can include a picture 306 of the specific vehicle with links 307 to see additional pictures, a text section 308 containing data from a validated data-record for the specific vehicle, a bid section 309, and a buy section 312. The bid section 309 can include a current bid field 310 illustrating the current bid for the vehicle and an input bid field 311 for the buyer to enter a bid. The buy field 3 12 can include a buy price 313 at which the seller agrees to sell the vehicle and withdraw it from the auction. The buy field 312 can also include additional data 314 and transportation links 315 to request other web pages from the auction server system regarding transporting the vehicle to the buyer.

FIG. 3D illustrates an itemized valuation section 317 on another portion of the detail page 300c. The itemized valuation 317 can include a wholesale pricing itemization of the specific vehicle provided by, or otherwise generated by, the auction server system. As described in more detail below, the itemized valuation 317 can include a list 318 of options and parts that use standard nomenclature, a corresponding value list 319 of wholesale values, a mileage adjustment amount 320, and a final valuation 321. The itemized valuation 317 can also include separate valuations from separate valuation services. As described in more detail below, one aspect of an embodiment is verifying the accuracy of the data on the detail page 300c, another aspect of an embodiment is developing the standard nomenclature for use in the nomenclature list 318, still another aspect of an embodiment is mapping the standardized/validated data to data provided by one or more valuation services (e.g., Kelley Blue Book, Black Book, NADA, etc.), and yet another aspect of an embodiment is providing for the transportation of the vehicle and coordinating the financial transactions of a full-service auction.

FIG. 3E illustrates an embodiment of a condition report 300e provided by the auction server system to a buyer system. The condition report 300e can include data about the vehicle from the data-record in the auction server database. In one embodiment, the condition report 300e includes a general condition report 322 identifying the vehicle and any general damage to the vehicle, a tire condition report 323 identifying the manufacturer and condition of the tires, and an appraisal report 324 estimating the repair cost for the mechanical, exterior, interior, glass, tires and other aspects of the car. The condition report 300e can also include a specific damage report 325 itemizing the particular damage of any item and the estimated repair cost of the appraisal report 324.

FIG. 3F illustrates an embodiment of another vehicle detail page 300f in accordance with an embodiment of the invention. The detail page 300f can include a display or picture 306 of the vehicle, a bid section 309 with an input field 311, and a buy section 312 that are similar to those described above with respect to FIG. 3C. The detail page 300f can also include a description section 350 that identifies the vehicle, an equipment section 352 that identifies the parts and options of the vehicle, a book summary section 360 having book link 362, and a condition summary section 364 having a condition link 366. The description section 350 can provide the general information about the make, model, series and styles of the vehicle, and the equipment section 352 and provide a detailed list of the particular parts and options on the vehicle. As described in more detail below, the nomenclature in the description section 350 and the equipment section 352 can be standardized so that a buyer and seller can obtain a good understanding of the vehicle without having to know the specific nomenclature used by a particular manufacturer or inspector. The book summary section 360 can provide a summary of the wholesale and retail book values for the vehicle, and the book link 362 can send a request to the auction server system to provide a detailed book-out page (shown in detail in FIG. 3G) that provides the book-out sheet with an itemization for the parts, options and mileage adjustments. The condition summary section 364 can provide a summary of the damage and an estimate of the repair costs, as determined by an inspector that inspected the vehicle, and the condition link 366 can send a request to the auction server system to send an itemized condition report (e.g., FIG. 3E).

The detail page 300f can also include a transportation section 370 describing the terms at which the electronic auctioneer will arrange for having the vehicle transported from a location provided by the seller to a buyer destination provided by the buyer. In this embodiment, the transportation section 370 includes a buyer destination 371 that identifies a location previously entered by the buyer to which the vehicle is to be shipped. The transportation section 370 also includes an estimated delivery period 372 and a transportation fee 373 based on the buyer destination 371. The transportation fee 373 can be retrieved from a database that includes estimated costs for transporting vehicles between various locations or generated by the auction server system. As explained in more detail below, the transportation fee can be determined by estimating the cost to transport a vehicle from one location to another and adding a service charge for arranging the transportation of the vehicles. The transportation fee 373 can be a guaranteed, fixed price such that the electronic auctioneer assumes the risk for finding a carrier that will deliver the vehicle from a seller location to the buyer destination.

After a buyer has viewed the vehicle on one of the detail pages 300c (FIG. 3C) or 300f (FIG. 3F), the buyer can return to the detail page 300c for entering a bid. FIG. 3H illustrates an embodiment of the detail page 300c for the Saab 9-5SE after a buyer has entered a bid in the bid input field 311. The buyer can bid on the vehicle using a proxy bid system known in the art, or other types of bidding procedures also known in the art. The buyer can enter the bid in the input field 311 in the auction by actuating button 328, or the buyer can outright buy the car for the listed buy price by actuating the button 329. If the buyer selects button 328 to enter the bid (e.g., $28,000) in the auction, the buyer system sends a message to the auction server system that the buyer is willing to pay up to $28,000 for the specific vehicle. The auction server system can then use this bid in a proxy bidding system known in the art.

Referring to FIG. 3I, the auction server system can send a bid confirmation 300g to the buyer system confirming that the current bid was entered and that the auction server system will bid the buyer up as needed to $28,000. The bid confirmation 300g can include a bid status field 330 identifying the status of the maximum bid amount, the current bid amount, and a processing fee. Additionally, the bid status page can include a shipping destination field 331 indicating the cost to ship the vehicle to the buyer and a button 332 for confirming the bid and finally committing the buyer to the bid.

FIG. 3J illustrates a confirmation message 300h sent by the auction server system to the buyer system confirming the bid entered by the buyer. The confirmation message 300h can be a web page or an e-mail message including a text section 333 indicating the status of the bid and whether the price meets the reserve price set by the seller. In the particular example shown in FIG. 3J, the bid price of $28,000 does not meet the reserve price set by the seller. The buyer can accordingly enter another bid or select the outright buy option. The confirmation message 300h can also include a link 334 to view the status of the bidding for the specific vehicle, and a timer 335 indicating the remaining time in the auction. After receiving the confirmation message 300h, the server system will notify the buyer system by e-mail if the buyer is outbid or wins the auction. At that point, an account page of the buyer will be updated indicating the status of the auction with respect to this particular vehicle.

FIGS. 3K-3M illustrate embodiments of web pages for applications in which the buyer actuates the button 329 (FIG. 3H) for buying the car at the buy price. FIG. 3K, more specifically, illustrates a purchase confirmation 300i having a text section 336 describing the details of purchasing the vehicle. When the purchase confirmation 300i is sent to the buyer system, the auction server system immediately withdraws the specific vehicle from auction and the buyer's account is updated. The buyer still has the opportunity to rescind the transaction, or the buyer can actuate a button 337 to agree to buy the specific vehicle in accordance with the terms and conditions of the electronic auctioneer. The purchase confirmation 300i can accordingly also include a plurality of links 338 that send requests to the auction server system to provide additional web pages describing the terms, conditions, and rules of the auction.

FIG. 3L discloses a final confirmation 300j that is sent by the auction server system to the buyer system in response to the buyer actuating the button 337 in FIG. 3I. The final confirmation 300j can include a description section 339 setting forth the final details of the transaction and a link 340 for printing a receipt of the transaction. In this embodiment, the description section 339 displays a purchase price 380 defining the amount that won the auction of the outright buy price for the vehicle, a transaction fee section 381 defining the amount that the electronic auctioneer receives for providing the auction, and a transportation fee 382 defining the amount that the electronic auctioneer agrees to charge for delivering the vehicle to the buyer destination. The transportation fee 373 of $1,100 shown in FIG. 3F is different than the transportation fee 383 of $265 shown in FIG. 3L because the two vehicles are likely shipped from different seller locations to different buyer destinations.

FIG. 3M illustrates an account summary report 300k having a description section 340 with a plurality of market summary links 341 and a plurality of auction summary links 342. The description section 340 can also include a purchase summary link 342. The market summary links 341 send requests from the buyer system to the auction server system that cause the auction server system to send various market summary web pages to the buyer system. The auction summary links 342 cause the auction server system to send additional pages regarding the current auctions that were previously closed in a particular time period (e.g., one-month). Lastly, the purchase summary link 343 sends a request from the buyer system to the auction server system to send additional pages regarding the used vehicles purchased by the buyer in the previous month, or within some other time period. The embodiment of the account summary report 300k shown in FIG. 3M accordingly reflects that the buyer purchased one used vehicle at a total cost of $30,540 corresponding to the Saab 9-S5E shown in FIGS. 3A-3D.

FIG. 3N illustrates another embodiment of an account summary report 300n having another embodiment of the description section 340 that also includes an account status section 344. In this embodiment, the account status section 344 indicates the number of open purchases for a buyer and a status link 345. For the purpose of the summary report 300n, open purchases include vehicles that have been purchased by the buyer and are in transit and/or await payment from the buyer. The status link 345 sends a request to the auction server system to provide an itemized report describing the particular vehicles that are on the open purchase list of a buyer.

B. Selected Embodiments of Preparing Accurate Data-records and Transporting Vehicles in Full Service Business-To-Business Electronic Auctions of Used Vehicles

In light of the embodiments of the business-to-business electronic auction of used vehicles set forth above with reference to FIGS. 1-3N, FIGS. 4-11 set forth several embodiments of systems and methods for validating the data provided by the seller, standardizing the nomenclature to ensure that the auction server system represents the vehicles accurately during an auction, and providing a full-service electronic auction that arranges for the transportation of the vehicles and the appropriate payment to the relevant parties.

FIG. 4 is a block diagram illustrating an embodiment of an arrangement that supports a business-to-business electronic auction of used vehicles over the Internet using the World Wide Web. This embodiment includes an electronic auction server system 402, a plurality of seller systems 404, and a plurality of buyer systems 405. The auction server system 402 can include a server engine 407, a web page generator 408 for generating a plurality of web page, and a plurality of modules and databases. The server engine 407 receives HTTP requests for web pages identified by URLs, and the server engine 407 causes the web page generator 408 to generate the requested web pages for display at the seller systems 404 and/or the buyer systems 405. The HTTP requests from the seller systems 404 are generally related to entering data into the auction server system and monitoring the status of vehicles in an electronic auction as described above with reference to FIGS. 2A-2J. The HTTP requests from the buyer systems 405 generally relate to searching for vehicles in an auction, participating in an auction, and monitoring the status of bids during an auction as described above with reference to FIGS. 3A-3N. The seller systems 404 and the buyer systems 405 also use HTTP requests for confirming purchases and completing transactions for selling/purchasing used vehicles.

The auction server system 402, the seller systems 404, and the buyer systems 405 interact by exchanging information via communication links 406. The communication links 406 may include transmission over the Internet, but a person skilled in the art will appreciate that the processes of providing information to the auction server system 402 and participating in the electronic auction can be used in environments other than the Internet. For example, the sellers and the electronic auctioneer can exchange data on a vehicle for uploading to an auction in an electronic mail environment in which the communications are transmitted in electronic mail messages. Similarly, several communications between the buyers and the auction server system can also be performed in an electronic mail environment, including confirmations, status reports and other communications. Various additional communication channels may also be used, such as local area networks, wide area networks, or point-to-point dial-up connections. The communications for the electronic auction can accordingly involve many other transmission media either in addition to or in lieu of the Internet. The electronic auction server system 402, the seller systems 404, and the buyer systems 405 may also comprise any combination of hardware or software that can process data for uploading a data-record regarding a vehicle to an electronic auction, pricing a vehicle, and performing an electronic auction for used vehicles. The electronic auction server system 402, for example, can be a high-speed system with a large memory and high-speed connections. The seller systems 404 and the buyer systems 405 can comprise virtually any combination of hardware and software that can interact with the electronic auction server system 402.

The electronic auction server system 402 can include a temporary file database 409 that contains initial data-records including the initial, non-validated data provided by the sellers. The initial data-records in the temporary file database are created using electronic transmissions from the seller systems 404, or downloading data from storage media provided by the sellers. The data-records in the temporary file database can accordingly be created using Internet communications, email messages, and downloads from CDs, portable electronic inventory units or other devices. In general, the initial data provided by the seller includes at least the VIN, make and model of a vehicle to establish an initial data-record in the temporary file. The sellers preferably provide additional data including the vehicle styles, parts, options, and an inspection report from a third-party inspector. In one especially useful embodiment, the initial data is collected using hand-held inspection units that have designated fields for the VIN, make, model, parts, options, and damage/condition information in a check-list format. The inspection units can have electronic pull-down menus, touch-sensitive displays, and keyboard or stylus-type (e.g., PAD writing) input devices. The inspection units can also use menus and check lists with standardized nomenclature and electronic pages similar to the pages 200c-200f above. The electronic server system can review the initial data-records in the temporary file database to determine whether they have sufficient data to proceed with validating the initial data. If the electronic auction server system determines that the data is insufficient, it can send a message to the particular seller system requesting the missing data. If the electronic server system indicates that the initial data-record is sufficient to proceed with validating the data, the seller can instruct the electronic server system to proceed with processing the data to prepare the data-record for uploading to an electronic auction.

The electronic auction server system also includes a VIN validation module 410 for processing a VIN validation routine using algorithms that check the format of VINs. The validated VINs can be stored in a VIN database 412. In operation, the VIN validation module uses the algorithms and/or the VINs in the VIN database to determine whether the VIN provided by the seller for a particular vehicle is valid. If the VIN is invalid, the electronic auction server system sends a message to the corresponding seller system requesting a revised VIN. If the VIN validation module determines that the VIN provided by the seller is valid, then the electronic auction server system proceeds with validating and augmenting the initial data in the data-record for a specific vehicle.

The electronic auction server system can also include a data validation module 420, a reference database 422, and a rules database 424. The reference database contains reference data-records regarding the make, model, vehicle styles, parts, and options for specific vehicles. The reference database, for example, can be organized by VINs or other suitable criteria such that each VIN will have corresponding reference data regarding the make, model, series, styles and other features for a specific vehicle. The reference data in the reference database can be obtained from vehicle manufacturers or third parties (e.g., Chrome Data Corporation). The rules database 424 includes particular rules that apply to the cars owned by a particular seller. For example, a rental car company or another large fleet operator may have rules regarding the type of transmission, engines and other features of the automobiles that they own.

In operation, the data validation module 420 analyzes the make, model, parts and options that are available on the specific vehicle according to the reference data in the reference database. The data validation module then compares the initial data in the initial data-record with the corresponding reference data to (a) validate the accuracy of the initial data in the data-record of the temporary file database, (b) correct initial data to correspond to the reference data, (c) add any additional data to the initial data data-record, and (d) remove any redundant data. At this point, the data validation module can create a temporary validated data-record for the particular vehicle that includes the correct initial data in the temporary file database that corresponds to the reference data in the reference database, and any additional reference data from the reference database that was not in the initial data-record. If the initial data cannot be reconciled with the reference data, then the data validation module prompts the electronic auction server system to send a message to the corresponding seller system requesting additional information and/or clarification. The data validation module also checks the initial data and reference data against any specific rules that the particular seller has in the rules database. In general, the data validation module overrides any data in either the initial data-record in the temporary file database and any reference data from the reference database that conflicts with the seller rules for a particular seller. After the electronic auction server system has validated the initial data in the initial data-record and augmented the initial data-record using the reference database, the rules database and/or additional information from the seller, the data validation module creates a validated data-record containing validated data for the specific vehicle.

The electronic auction server system also includes a nomenclature module 430 and a standard nomenclature database 432 containing standardized nomenclature for the various makes, models, parts and options for used vehicles. In general, the term “make” refers to the manufacturer of the vehicle, the term “model” refers to the general name given to the vehicle by the manufacturer, and the term “style” refers to the series of the vehicle, the body type of the vehicle, and the general aspects of the vehicle (e.g., four-door or two-door, engine type, etc.). The features of the vehicles are further broken down according to the “parts” of the vehicle, such as electric windows, air conditioning, audio components, roofs and other features of the vehicle. The “parts” can be further broken down into options, such as leather/cloth seating, towing packages, wheels, etc. One useful technique for obtaining quality data is to consistently input unambiguous information into the database. The sellers, however, often do not use consistent terminology to describe the vehicles. For example, a data feed for two Chevrolet Trailblazers might describe the vehicle as a “Trail Blazer” or a “Trailblazer,” or a data feed may describe the audio system as a “stereo” when it is a “CD Player-single-with an AM/FM Radio (no tape).” The nomenclature module 430 uses the standard nomenclature database to reconcile any such differences in data feeds from the seller systems. In operation, the nomenclature module 430 maps the validated data in the validated data-record to standardized nomenclature in the nomenclature database 432 to create standardized/validated data contained in a standardized/validated data-record.

The auction server system can also include a valuation module 440 and a valuation service database 442. The electronic auction server system preferably includes a plurality of valuation service databases, such as a database for each of the Kelley Blue Book, Black Book and/or NADA valuation services. In operation, the valuation module maps the standardized/validated data in a standardized/validated data-record to the valuation data in the valuation service databases. The valuation module can then produce an itemized valuation for the specific vehicle for each of the valuation services selected by a buyer. At this point, the standardized/validated data-record and an itemized valuation data-record can be used to upload the vehicle to an active auction.

The electronic auction server system also includes an active auction module 450 for processing an active auction, an accounting module 460 for tracking the financial transactions between the buyers and sellers, and an inventory processing module 470 for tracking the inventory of vehicles from the temporary file database 409 through the processes of validating the data-records, standardizing the nomenclature, valuating the vehicles, auctioning the vehicles, and transporting the vehicles. The active auction module 450 supports an active auction for a plurality of vehicles between a plurality of buyers and sellers. The auction module 450 can present a vehicle at an auction by sending a vehicle detail page to a buyer in response to a request from the buyer to view the vehicle. The active auction module 450 can also process the bids using a proxy bidding process known in the ail or another type of bidding process. The active auction module 450 operates with the inventory tracking module 470 for presenting vehicles to buyers, removing sold vehicles from the auction, and tagging sold vehicles for processing using the accounting module 460. If a vehicle is sold at the auction, the accounting module 460 determines the amount owed by buyer to the electronic auctioneer, the amount owed by the electronic auctioneer to the seller, and any amounts owed by the electronic auctioneer to third parties (e.g. vehicle transportation providers). The accounting module 460 can also arrange for messages to be sent to the buyers, sellers and third party providers, as well as arranging payment to the sellers and the third party providers.

In this embodiment, the auction server system further includes a transportation module 480. The transportation module 480 is coupled to a transportation database 482 that contains estimates of the costs to transport a vehicle between various locations. The transportation module 480 can prepare a transportation fee for use in a vehicle detail page to send to the buyer system by receiving an estimate of the transportation fee from the transportation database 482 or by determining an estimate of the transportation fee. If the buyer wins the auction, the transportation module 480 can also send a message to a vehicle carrier to pickup the vehicle at the seller location and transport it to the buyer destination.

The transportation fees for various situations can be calculated and stored in the transportation database 482 or determined in real time according to several different algorithms. Because the electronic auctioneer is at risk for providing the transportation of the vehicles at a price that is at least equal to the actual cost to transport the vehicles, it is desirable to determine accurate estimates of the transportation costs for the transportation database 482. In one embodiment, the algorithm is based upon the mileage between the current location of a vehicle (provided by a seller) and the buyer destination (provided by the buyer). For example, the transportation fee can be a straight line function, a step function or a non-linear function based on mileage. In another embodiment, the algorithm can be based upon the distance and cost to transport several vehicles between major metropolitan areas, and any additional costs to transport the individual vehicles from the metropolitan areas to the buyer destinations. The electronic auctioneer can also establish agreements with carriers, such as railroad and truck carriers, for transportation based upon the mileage and the number of vehicles. The transportation fee displayed by the electronic auctioneer can be an amount for hauling a single vehicle so that the electronic auctioneer can keep any volume discounts that it receives as profit. The transportation module 480 can accordingly provide a transportation fee for a vehicle detail page (among others) and arrange for the transportation of the vehicle from the seller location to the buyer destination.

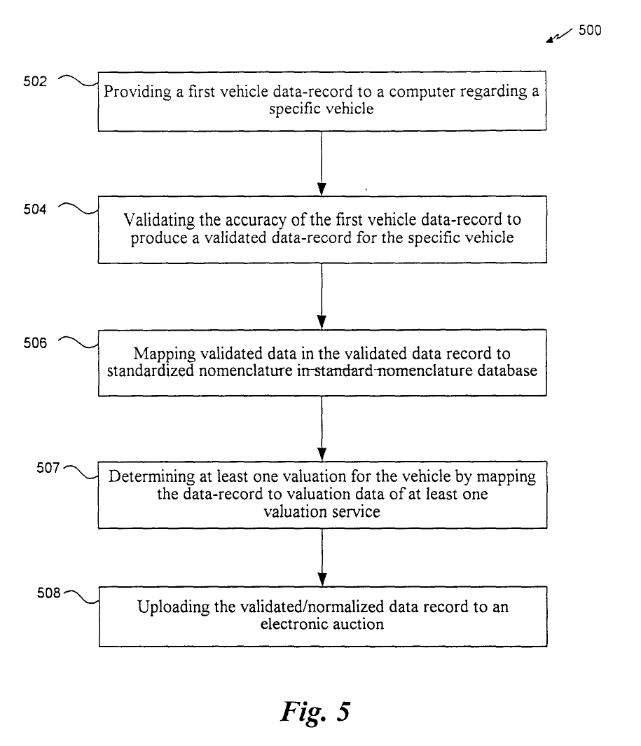

FIG. 5 is a flow diagram of an upload valuation routine 500 to provide at least one wholesale and/or retail valuation regarding a vehicle for performing a business-to-business electronic auction of used vehicles between large-volume sellers and institutional buyers via an auction server system. The upload routine 500, for example, can include a data feed procedure 502 that provides a first vehicle data-record containing initial data regarding a specific vehicle. The first vehicle data-record can be stored in the temporary file database of the electronic auction server system. The upload routine 500 continues with a data validation procedure 504 that validates the accuracy of the initial data in the first data-record to produce a validated data-record for the specific vehicle. The initial data in the first data-record can be validated using the VIN validation module and the data validation module of the auction server system described above with reference to FIG. 4. After validating the data in the first data-record, the upload routine 500 can proceed to a standardization procedure 506 that maps the validated data in the validated data-record to standardized nomenclature using the nomenclature module and the standard nomenclature database described above. The upload routine 500 can then proceed to a valuation procedure 507 in which the standardized/validated data-records are mapped to data provided by valuation services to provide at least one valuation for the vehicle. The upload routine 500 can alternatively proceed from the validating procedure 504 directly to the valuation procedure 507 without performing the standardization procedure 506 such that the valuation is based upon the validated data-record. The upload routine 500 can then continue with the load procedure 508 to load both the standardized/validated data-record and a corresponding valuation data-record to an electronic auction. The electronic auction server system, for example, uses the standardized/validated data-record and/or the valuation data-record to generate the web pages 2A-3K for preparing, monitoring and executing a business-to-business electronic auction for used vehicles.

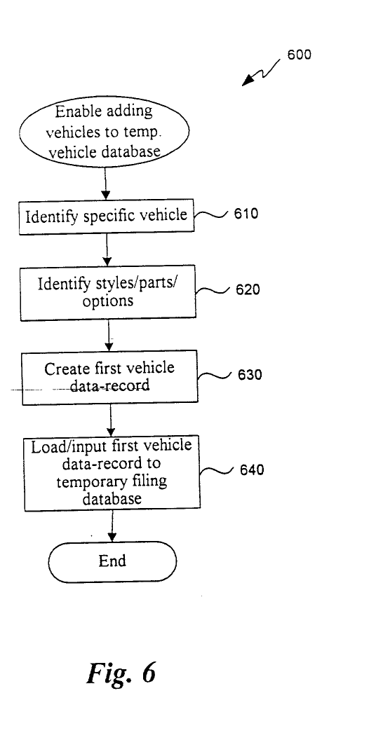

FIG. 6 is a flow diagram of an initial data feed routine 600 for enabling the addition of vehicles to a temporary vehicle database related to the data feed procedure 506. The initial data feed routine 600 includes a vehicle identification procedure 610 in which the seller identifies the VIN, make, model and series of the specific vehicle. The data feed routing also includes a feature identification procedure 620 in which the seller identifies the styles, parts and options of the specific vehicle. The vehicle identification procedure 610 and the feature identification 620 procedure can be performed electronically using hand-held, portable units having software with pull-down menus and data entry fields. In a typical application, a seller will hire an independent inspector to obtain the data for performing the vehicle identification and the feature identification procedures. It will be appreciated that the sellers can use non-electronic methods to obtain the data for the vehicle identification procedure and the feature identification procedure. The data feed routine 600 continues with a first data-record procedure 630 in which the seller or the auction server system creates a first vehicle data-record for the specific vehicle containing the initial data obtained in the vehicle identification procedure and the feature identification procedure. The data feed routine 600 also includes a load/input procedure 640 in which the first vehicle data-records are loaded into the temporary file database 409 of the electronic auction server system. The load/input procedure can be performed by sending the first data-records to the electronic auction server system 402 electronically, or the electronic auctioneer can copy the first vehicle data-records from storage media to the electronic auction server system 402. After loading the first vehicle data-records into the temporary file database of the electronic auction server system, several embodiments of methods in accordance with the invention proceed by verifying whether the VIN provided in the first vehicle data-records is a valid VIN for a vehicle.

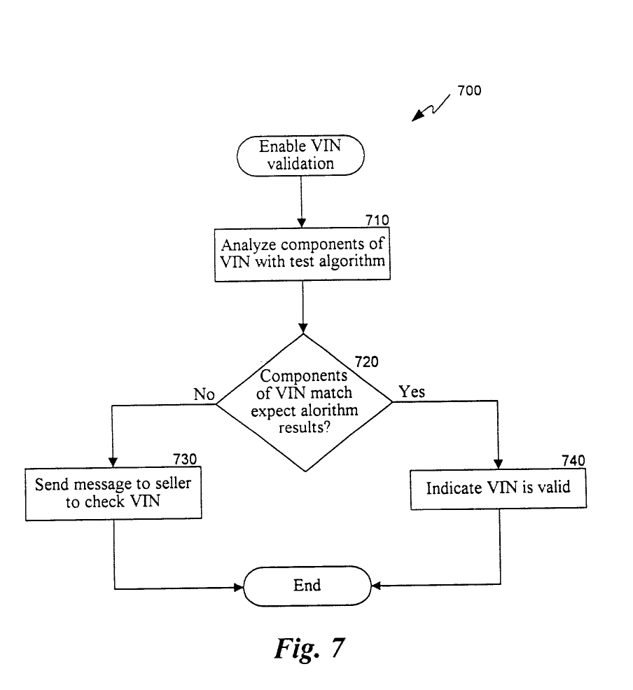

FIG. 7 is flow diagram of a VIN validation routine 700 for enabling the electronic auction server system to validate the VIN of a first vehicle data-record provided to the auction server system. The VIN validation routine 700 includes an analyzing procedure 710 in which the VIN is processed through a test algorithm that compares components of the VIN with standard VIN protocols established by the industry. The test algorithm used in the analyzing procedure 710 can be a standard test algorithm known in the industry or a unique test algorithm developed by the electronic auctioneer that is within the skill of one skilled in the art who is familiar with the VIN protocols. The VIN validation routine 700 includes a decision procedure 720 in which the electronic auction server system 402 assesses whether the components of the VIN match the expected algorithm results for a valid VIN. If the components of the VIN do not match the expected algorithm results, the VIN validation routine continues with a correction procedure 730 in which the electronic auction server system or the electronic auctioneer sends a message to the seller to check the VIN and provide a corrected VIN. The correction procedure 730 can be performed by the electronic auction server system by sending an e-mail message to the seller system, or the correction procedure 730 can be performed using other communication means. Referring back to the decision procedure 720, if the components of the VIN match the expected algorithm results, then the VIN validation routine 700 proceeds with a verification routine 740 in which the validity of the VIN is indicated as being verified. After validating the VIN, the electronic auction server system validates, corrects and augments the initial data in the initial data-record.

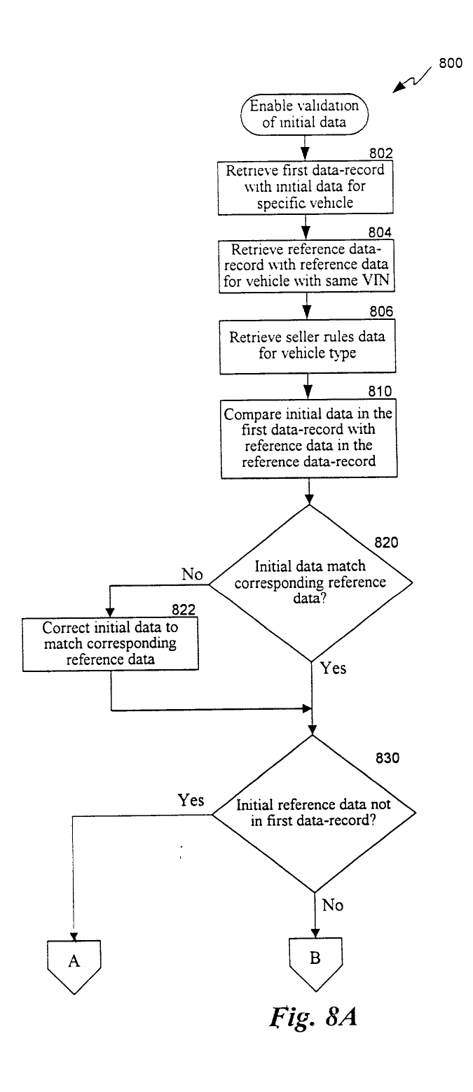

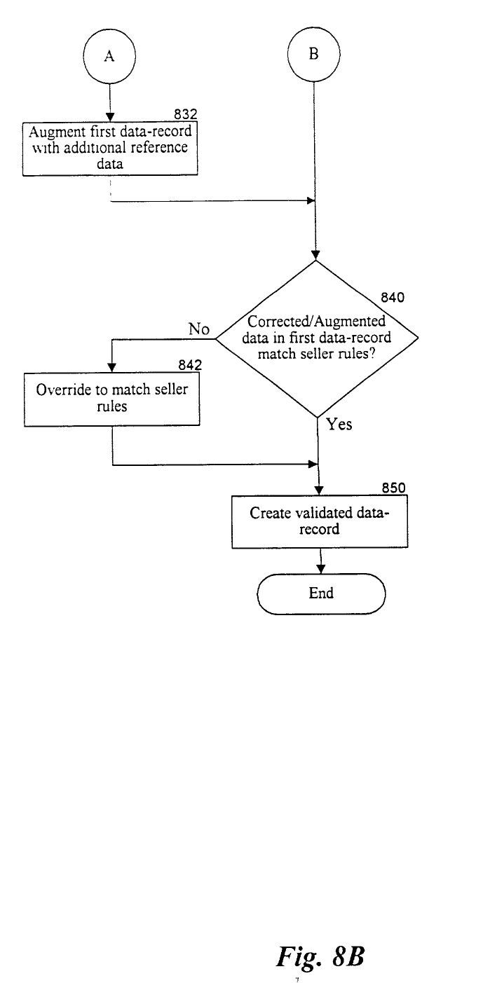

FIGS. 8A and 8B are a flow diagrams of a data validation routine 800 for validating the initial data in the first data-record stored in the temporary file database. The data validation routine 800 is typically performed by the data validation module 420 using the reference database 422 and the seller rules database 424 (FIG. 4). Referring to FIG. 8A, the data validation routine 800 includes a first retrieval procedure 802 in which the initial data in the first data-record for a specific vehicle is retrieved from the temporary file database, a second retrieval procedure 804 in which reference data from the reference database 422 is retrieved, and a third retrieval procedure 806 in which the seller rules for the particular seller are retrieved. The data validation routine 800 continues with a comparing procedure 810 in which the initial data in the first data-record is compared with the reference data in the reference database. As set forth below, the comparing routine 810 can include several independent decision-making procedures to correct and augment the data in the first data-record for creating a validated data-record.

Still referring to FIG. 8A, the comparing: procedure 810 of the data validation routine 800 can include a first decision procedure 820 in which the data validation module determines whether the initial data in the first data-record matches corresponding reference data from the reference database. If the initial data does not match the corresponding reference data in the first decision procedure 820, the data validation routine 800 proceeds to a correction procedure 822 in which the initial data is corrected to match the corresponding reference data. If the data matches, or after performing the correction procedure 822, the data validation routine 800 continues with a second decision procedure 830 in which the data validation module determines whether the reference database includes additional data about the vehicle that is not included in the initial data contained in the first data-record. Referring to FIGS. 8A and 8B together, if the reference database includes additional data, the data validation routine 800 proceeds to an augmentation procedure 832 in which the first data-record is augmented with the additional reference data from the reference database. If the reference database does not include any additional data, or after completing the augmentation procedure 832, the data validation routine 800 proceeds with a seller rules decision 840 (FIG. 8B) in which the corrected/augmented data in the first data-record is compared with the seller rules. If the corrected/augmented data in the first data-record does not match the seller rules, the data validation routine 800 continues with an override procedure 842 in which the data in the first data-record that does not match the seller rules is overridden to correspond to the seller rules. After completing the override procedure 842, or if the corrected/augmented data in the first data-record matches the seller rules, the data validation routine 800 continues with a validated data-record routine 850 in which a validated data-record for the vehicle is created.

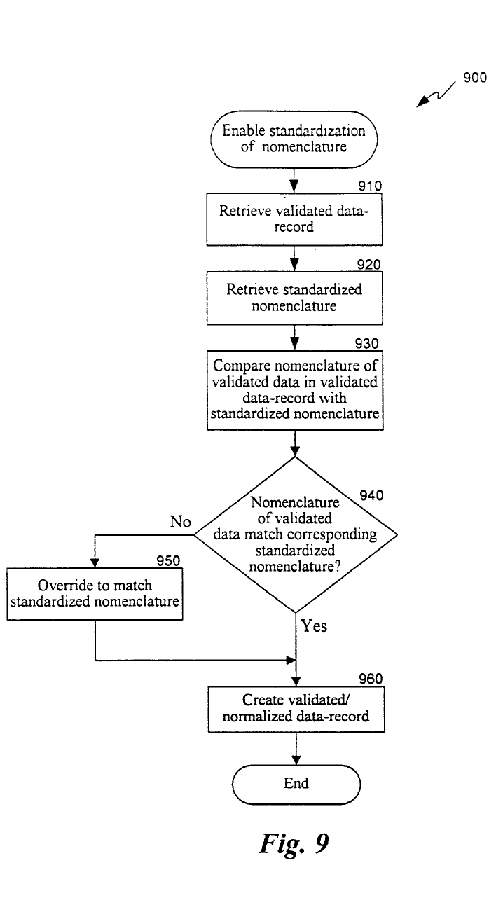

FIG. 9 is a flow diagram of a standardization routine 900 for standardizing the nomenclature of the validated data in the validated data-record. The standardization routine 900 can be performed by the standard nomenclature module 430 using the standard nomenclature database 432 in the electronic auction server system 402 (FIG. 4). The standardization routine 900 includes a first retrieval procedure 910 for retrieving the validated data-record corresponding to the specific vehicle, and a second retrieval procedure 920 for retrieving the standard nomenclature from the standard nomenclature database. The standardization routine 900 continues with a comparing procedure 930 in which the nomenclature of the validated data in the validated data-record is compared with the standard nomenclature from the standard nomenclature database. The nomenclature standardization routine 900 continues with a decision procedure 940 that determines whether the nomenclature of the validated data matches the corresponding standard nomenclature. If the nomenclature in the validated data-record does not match the corresponding nomenclature, the standardization routine 900 continues with an override procedure 950 in which the nomenclature of the validated data is changed to match the standard nomenclature. After performing the override procedure 950, or if the nomenclature of the validated data matches corresponding nomenclature in the standard nomenclature database, the standardization routine 900 continues with a finalized data-record routine 960 in which a standardized/validated data-record for the specific vehicle is created and stored in the electronic auction server system 402.

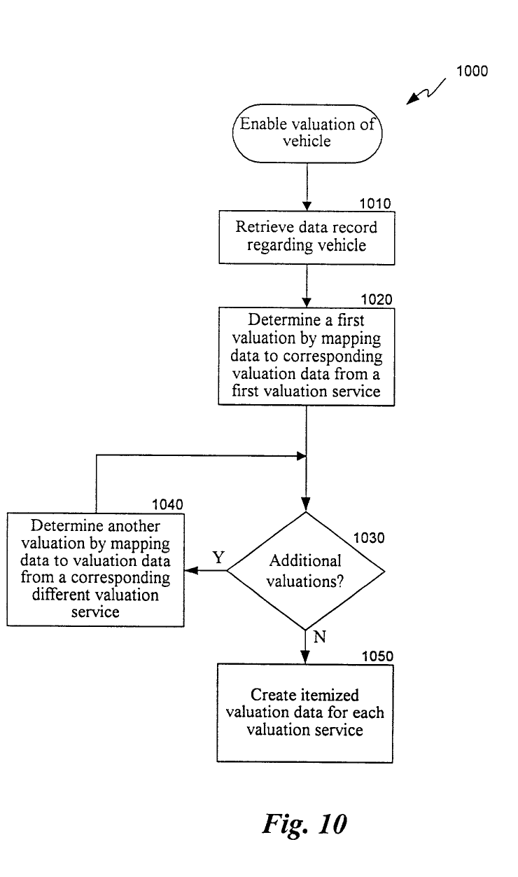

FIG. 10 is a flow diagram of a valuation routine 1000 for providing a wholesale and/or retail valuation of a vehicle. The valuation routine 1000 can be performed by the valuation module 440 using the valuation service databases 442 in the electronic auction server system 402 (FIG. 4). The valuation routine 1000 includes a retrieval procedure 1010 for retrieving data regarding the vehicle. The retrieval procedure 1010 that can retrieve the validated data-record, the standardized/validated data-record, or another data-record regarding the specific vehicle. The valuation routine 1000 continues with a determining procedure 1020 in which the auction server system determines a first valuation for the specific vehicle by mapping the data retrieved in the retrieval procedure 1010 to corresponding valuation data from a first valuation service. In an embodiment in which the retrieved data comprises the validated data-record or the standardized/validated data-record for the specific vehicle, the determining procedure 1020 maps the itemized valuation data from the first valuation service to the data contained in the data-record for the specific vehicle. The determining procedure 1020 can be performed by storing the valuation data of at least one valuation service (e.g., Kelly Blue Book, Black Book, NADA, etc.) in the valuation database 442, or by accessing a database contained in a valuation server system operated by an independent valuation service. The valuation routine 1000 continues with a decision procedure 1030 that determines whether additional valuations of the vehicle are desired. If additional valuations are desired, the valuation routine 1000 continues with a second determining procedure 1040 in which another valuation is determined by mapping the retrieved data to corresponding data from a different valuation service. For example, if the first determining procedure 1020 determined a first valuation based upon a valuation database provided by Kelly Blue Book, the second determining procedure 1040 can determine a second valuation based upon a database provided by the Black Book valuation service. After performing the second determining procedure 1040, or if no additional valuations are desired at the decision procedure 1030, the valuation routine 1000 continues with a finalized valuation-record routine 1050 in which an itemized valuation is created for each valuation service. The itemized valuation can be stored in the electronic auction server system, or it can be generated and uploaded to a web page upon demand.

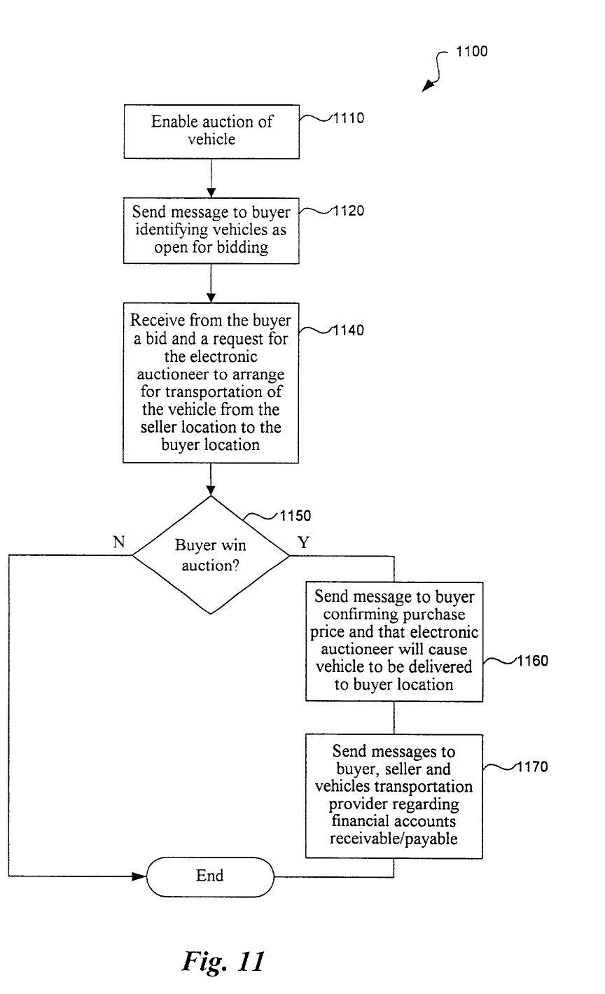

FIG. 11 is a flow diagram of a transportation routine 1100 for providing transportation of the vehicle from a seller location where the seller is holding the vehicle to a buyer destination where the buyer wants the vehicle to be delivered. The transportation routine can be performed by the transportation module 480 using the transportation database 482 in the electronic auction server system 402. The transportation routine includes a first correspondence procedure 1110 in which the auction server system can send a message to the buyer that indicates the vehicle is open for bidding. In response to a request from the buyer to view the vehicle, the transportation routine can receive a transportation fee from a database or otherwise determine a transportation fee for uploading to a section of a vehicle detail page 300f (FIG. 3F). The transportation section, for example, can provide the transportation fee at which the electronic auctioneer will be responsible for transporting the vehicle to the buyer destination. The transportation routine then proceeds to a bid procedure in which the auction server system receives a bid from the buyer and a request that the electronic auctioneer provide for the transportation of the vehicle from the seller location to the buyer destination. The transportation routine continues with a decision routine 1140 which determines whether the buyer won the auction. If the buyer wins the auction, the transportation routine continues with a transportation confirmation procedure 1150 in which the auction server system sends a confirmation of the purchase price and the transportation fee to the buyer, and further continues with a financial transaction procedure 1160 in which the auction server system sends messages to the buyer, seller and vehicle transportation provider to coordinate payment for the sale and transportation of the vehicle.

Many specific details of certain embodiments of the invention have been described in the foregoing description with respect to FIGS. 1-11 to provide a thorough understanding of these embodiments. One skilled in the art, however, will understand that the present invention may have additional embodiments, or that the invention may be practiced without several of the details described above. From the foregoing, therefore, it will be appreciated that various modifications may be made without deviating from the spirit and scope of the invention. Accordingly, the invention is not limited except as by the appended claims.

1. A method in a computer operated by an electronic auctioneer for conducting an electronic auction of a vehicle, comprising:
receiving an indication from a potential buyer of a buyer destination for delivery of vehicles purchased by the potential buyer;
providing a description of a vehicle to be auctioned to the potential buyer, the description including a transportation section having a transportation fee that the electronic auctioneer agrees to be responsible for transporting the vehicle to the buyer destination; and
receiving a response from the potential buyer indicating (a) a bid price for purchasing the vehicle and (b) that the electronic auctioneer is to arrange for transporting the vehicle to the buyer destination for the transportation fee.

2. The method of claim 1 wherein providing a description having a transportation section comprises constructing a message including the transportation fee being equal to an estimated transportation cost based on mileage between a current location of the vehicle and the buyer destination.

3. The method of claim 1 wherein providing a description having a transportation section comprises constructing a message including the transportation fee being equal to an estimated transportation cost based on a first mileage between a current location of the vehicle and a first transportation hub, a second mileage between the buyer destination and a second transportation hub, and a third mileage between the first and second transportation hub.

4. The method of claim 1 wherein providing a description having a transportation section comprises constructing a message including the transportation fee being equal to an estimated transportation cost based on mileage between a current location of the vehicle and the buyer destination plus a coordination charge for arranging transportation of the vehicle.

5. The method of claim I wherein providing a description having a transportation section comprises constructing a message including the transportation fee being equal to a coordination charge for arranging transportation of the vehicle and an estimated transportation cost based on a first mileage between a current location of the vehicle and a first transportation hub, a second mileage between the buyer destination and a second transportation hub, and a third mileage between the first and second transportation hub.

6. The method of claim 1, further comprising arranging for transportation of the vehicle in the computer by:
sending a message to a vehicle carrier to transport the vehicle from a current location of the vehicle to the buyer destination; and
paying the vehicle carrier actual transportation costs for transporting the vehicle.

7. The method of claim 1, further comprising sending a transportation inquiry to the buyer before providing a description of the vehicle, the transportation inquiry having an input section for the buyer to select the buyer destination.

8. A method in a computer operated by an electronic auctioneer for conducting an electronic auction of a vehicle, comprising:
in response to a request from a buyer system, sending a vehicle detail message from an auction server system to the buyer system for entering a bid regarding a vehicle, the vehicle detail message including a vehicle description section, a transportation section defining an amount at which the electronic auctioneer will cause the vehicle to be transported to a buyer destination, and a bid input section;
receiving from the buyer system (a) a request to enter a bid price for purchasing the vehicle and (b) an agreement for the electronic auctioneer to arrange for transporting the vehicle to the buyer destination; and
if the buyer system wins the auction, sending a transaction message from the auction server system to the buyer system indicating that the buyer has won the auction and that the electronic auctioneer will arrange for transportation of the vehicle to the buyer destination.

9. The method of claim 8 wherein sending a vehicle detail message with a transportation section comprises:
retrieving a transportation fee from a transportation database based on mileage between a current location for the vehicle and the buyer destination; and
constructing a web page including the transportation fee in the transportation section and a commitment from the electronic auctioneer to deliver the vehicle to the buyer location for the transportation fee.

10. The method of claim 8 wherein sending a vehicle detail message with a transportation section comprises:
retrieving a transportation fee from a transportation database equal to a management fee plus a transportation cost based on mileage between a current location for the vehicle and the buyer destination; and
constructing a web page including the transportation fee in the transportation section and a commitment from the electronic auctioneer to deliver the vehicle to the buyer location for the transportation fee.

11. A method in a computer operated by an electronic auctioneer for conducting an electronic auction of a vehicle, comprising:
receiving an indication from a potential buyer of a buyer destination for delivery of vehicles purchased by the potential buyer;
providing a description of a vehicle to be auctioned to the potential buyer, the description including a transportation section having a transportation fee at which that the electronic auctioneer agrees to arrange and be responsible for transporting the vehicle to the buyer destination;
receiving a response from the potential buyer indicating (a) a bid price for purchasing the vehicle and (b) that the electronic auctioneer is to arrange for transporting the vehicle to the buyer destination for the transportation fee; and
if the buyer wins the auction for the vehicle, (a) receiving from the buyer a remittance amount for at least the bid price and the transportation fee, (b) paying the seller a sales amount for the vehicle, and (c) paying a carrier to transport the vehicle from a current location to the buyer destination.

12. The method of claim 11 wherein providing a description having a transportation section comprises constructing a message including the transportation fee being equal to an estimated transportation cost based on mileage between a current location of the vehicle and the buyer destination.

13. The method of claim 11 wherein providing a description having a transportation section comprises constructing a message including the transportation fee being equal to an estimated transportation cost based on a first mileage between a current location of the vehicle and a first transportation hub, a second mileage between the buyer destination and a second transportation hub, and a third mileage between the first and second transportation hub.

14. The method of claim 11 wherein providing a description having a transportation section comprises constructing a message including the transportation fee being equal to an estimated transportation cost based on mileage between a current location of the vehicle and the buyer destination plus a coordination charge for arranging transportation of the vehicle.

15. The method of claim 11 wherein providing a description having a transportation section comprises constructing a message including the transportation fee being equal to a coordination charge for arranging transportation of the vehicle and an estimated transportation cost based on a first mileage between a current location of the vehicle and a first transportation hub, a second mileage between the buyer destination and a second transportation hub, and a third mileage between the first and second transportation hub.

16. The method of claim 11, further comprising arranging for transportation of the vehicle in the computer by:
sending a message to a vehicle carrier to transport the vehicle from a current location of the vehicle to the buyer destination; and
paying the vehicle carrier actual transportation costs for transporting the vehicle.

17. The method of claim 11, further comprising sending a transportation inquiry to the buyer before providing a description of the vehicle, the transportation inquiry having an input section for the buyer to select the buyer destination.

18. A method in a computer operated by an electronic auctioneer for conducting an electronic auction of a vehicle, comprising:
in response to a request from a buyer system, sending a vehicle detail message from an auction server system to the buyer system for entering a bid regarding a vehicle, the vehicle detail message including a vehicle description section, a transportation section defining an amount at which the electronic auctioneer will cause the vehicle to be transported to a buyer destination, and a bid input section;
receiving from the buyer system (a) a request to enter a bid price for purchasing the vehicle and (b) an agreement for the electronic auctioneer to arrange for transporting the vehicle to the buyer destination; and
if the buyer system wins the auction, sending a transaction message from the auction server system to the buyer system indicating that the buyer has won the auction and that the electronic auctioneer will arrange for transportation of the vehicle to the buyer destination.

19. A computer-readable medium containing instructions for causing a computer system to conduct an electronic auction of vehicles by a method comprising:
receiving an indication from a potential buyer of a buyer destination for delivery of vehicles purchased by the potential buyer;
providing a description of a vehicle to be auctioned to the potential buyer, the description including a transportation section having a transportation fee that an electronic auctioneer agrees to be responsible for transporting the vehicle to the buyer destination; and
receiving a response from the potential buyer indicating (a) a bid price for purchasing the vehicle and (b) that the electronic auctioneer is to arrange for transporting the vehicle to the buyer destination for the transportation fee.

20. A computer-readable medium containing instructions for causing a computer system to conduct an electronic auction of vehicles by a method comprising:
in response to a request from a buyer system, sending a vehicle detail message from an auction server system to the buyer system for entering a bid regarding a vehicle, the vehicle detail message including a vehicle description section, a transportation section defining an amount at which the electronic auctioneer will cause the vehicle to be transported to a buyer destination, and a bid input section;
receiving from the buyer system (a) a request to enter a bid price for purchasing the vehicle and (b) an agreement for an electronic auctioneer to arrange for transporting the vehicle to the buyer destination; and
if the buyer wins the auction, sending a transaction message from the auction server system to the buyer system indicating that the buyer has won the auction and that the electronic auctioneer will arrange for transportation of the vehicle to the buyer destination.

21. A computer-readable medium containing instructions for causing a computer system to conduct an electronic auction of vehicles by a method comprising:
receiving an indication from a potential buyer of a buyer destination for delivery of vehicles purchased by the potential buyer;
providing a description of a vehicle to be auctioned to the potential buyer, the description including a transportation section having a transportation fee that an electronic auctioneer agrees to arrange and be responsible for transporting the vehicle to the buyer destination;
receiving a response from the potential buyer indicating (a) a bid price for purchasing the vehicle and (b) that the electronic auctioneer is to arrange for transporting the vehicle to the buyer destination for the transportation fee; and
if the buyer wins the auction for the vehicle, (a) arranging for transportation of the vehicle to the buyer destination, (b) receiving from the buyer a remittance amount for at least the bid price and the transportation fee, and (c) paying the seller a sales amount for the vehicle.
